(19) United States
(12) Patent Application Publication
(10) Pub. No.: US 2026/0136327 A1
(43) Pub. Date: May 14, 2026

(54) ZONE CONFIGURATION INDICATION FOR CONNECTED VEHICLE GROUPCAST COMMUNICATIONS

(71) Applicant: QUALCOMM Incorporated, San Diego, CA (US)

(72) Inventors: Hui GUO, Beijing (CN); Tien Viet NGUYEN, Bridgewater, NJ (US); Dan VASSILOVSKI, Del Mar, CA (US); Shuanshuan WU, San Diego, CA (US); Kapil GULATI, Belle Mead, NJ (US)

(21) Appl. No.: 19/493,034

(22) PCT Filed: Sep. 8, 2023
(86) PCT No.: PCT/CN2023/117654

§ 371 Date: Dec. 12, 2025

(51) Int. Cl. H04W 64/00; H04L 1/1812; H04W 4/40; H04W 72/25; H04W 92/18

(52) U.S. Cl. CPC H04W 64/00; H04L 1/1812; H04W 4/40; H04W 72/25; H04W 92/18

(57) ABSTRACT

Systems and techniques are descried for providing enhanced zone configurations for V2X groupcast communications. For example, a computing device can determine a zone indication type for a groupcast message of the UE. The zone indication type is included in a configured plurality of zone indication types. The computing device can determine a zone identity (ID) for a current location of the UE. The current location of the UE is within a geographical zone corresponding to the zone ID, and the zone ID is selected from a plurality of zone IDs of the zone indication type. The computing device can determine range information for the groupcast message. The range information is indicative of a receive area within the geographical zone corresponding to the zone ID. The computing device can transmit sidelink information indicative of the zone ID and the range information. The computing device can transmit the groupcast message.

### FIELD

The present disclosure generally relates to vehicle communications. For example, aspects of the present disclosure relate to enhanced zone configurations for vehicle-to-everything (V2X) groupcast communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in vehicle-to-everything (V2X), vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Vehicle-to-everything (V2X) communications is a vehicular communication system that supports the wireless transfer of information from a vehicle to other entities (e.g., other vehicles, pedestrians with smart phones, equipped vulnerable road users (VRUs), such as bicyclists, roadside units (RSUs), and/or other traffic infrastructure) located within a traffic system that may affect the vehicle. V2X technology can be used to improve road safety, fuel savings, and traffic efficiency. V2X wireless communications can include distance-based groupcast messages between V2X UEs (e.g., also referred to as V2X-enabled UEs, V2X-capable UEs, and/or connected vehicles, etc.). For example, V2X distance-based groupcast messages can be used to broadcast information for purposes of situational awareness in which nearby vehicles are the relevant or intended receivers. In some examples, V2X distance-based groupcast can be used to broadcast information from a transmitting UE (e.g., a Tx UE) to a subset of nearby vehicle UEs or other entities (e.g., Rx UEs), for instance in order to share information about traffic conditions, road hazards, etc., among various other events that are only considered relevant to entities within the immediate vicinity of the Tx UE.

In some cases, a distance-based groupcast message can be used to broadcast data from a Tx UE to a group of one or more Rx UEs within a configured distance of the current location of the Tx UE. The current location of the Tx UE can be mapped to a particular zone identity (ID) that corresponds to a unique geographical area (e.g., zone) that encloses the current location of the Tx UE. The mapping between zone IDs to corresponding geographical areas can be based on zone configuration information provided by a network entity associated with the UEs. In some examples, the plurality of zone IDs can be implemented based on mapping a geodesic surface area (e.g., a portion of the surface of the earth) into a plurality of zones that are approximately 5 meter squares.

The configured distance for a V2X distance-based groupcast message can be implemented based on a range requirement value that corresponds to the radius of a circle centered on the current location (e.g., current zone ID) of the Tx UE. V2X-enabled or V2X-capable Rx UEs that are located within the specified minimum radius of the circle are required to correctly decode the packet(s) of the distance-based groupcast message. For example, an Rx UE can calculate a distance between the current Rx UE zone ID and the current Tx UE zone ID, and may be required to decode the V2X distance-based groupcast message if the calculated distance is less than or equal to the configured range requirement value indicated for the V2X distance-based groupcast message.

A two-dimensional (2D) zone indication may provide insufficient granularity to optimize distance-based groupcast transmission to only a specific subset of intended receivers (e.g., candidate Rx UEs for a particular V2X distance-based groupcast message). For instance, existing techniques based on 2D zone indication information cannot be used to specify an area of intended reception using a geometry other than a circle with a radius given by the minimum range require value. Additionally, 2D zone indication information does not indicate a directionality of interest for the intended candidate receivers (e.g., such as in an example where a Tx vehicle UE has data that is only of interest to other vehicles (Rx UEs) moving in the same direction). 2D zone indication information additionally does not indicate height information for intended candidate receivers, and cannot differentiate between candidate Rx UEs on different vertical levels of parking garages or highways, etc.

Systems and techniques are described herein for improved and enhanced zone ID configurations that can be used to extend V2X distance-based groupcast. In some aspects, the systems and techniques can be used to implement three-dimensional (3D) zone indications for a Tx UE and/or for one or more intended Rx UEs of a V2X groupcast message, for instance based on configuring the UEs with a 3D zone indication type and a 3D zone indication mode. In some aspects, the systems and techniques can be used to implement directional zone indications, for instance based on configuring the UEs with a directional zone indication type and a directional zone indication mode. In some examples, the intended receivers (e.g., Rx UEs) for a V2X groupcast message can be determined based on the enhanced zone indication information of the Tx UE, where the Tx UE enhanced zone indication information includes a 2D or 3D enhanced zone corresponding to the Tx UE, and additionally includes range information indicative of one or more of a non-circular area of the intended Rx UEs, height information of the intended Rx UEs, and/or directional information of the intended Rx UEs. In some aspects, the systems and techniques can additionally be used to implement reception zone determination and indication, where the area of intended Rx UEs for a V2X groupcast message is the intersection of the transmission zone indication (e.g., Tx UE zone ID) and the reception zone indication.

According to at least one illustrative example, an apparatus of a user equipment (UE) for wireless communications is provided. The apparatus includes at least one memory and at least one processor coupled to the at least one memory, wherein the at least one processor is configured to: determine a zone indication type for a groupcast message of the UE, wherein the zone indication type is included in a configured plurality of zone indication types; determine a zone identity (ID) for a current location of the UE, wherein the current location of the UE is within a geographical zone corresponding to the zone ID, and wherein the zone ID is selected from a plurality of zone IDs of the zone indication type; determine range information for the groupcast message, wherein the range information is indicative of a receive area within the geographical zone corresponding to the zone ID; transmit sidelink information indicative of the zone ID and the range information; and transmit the groupcast message.

In another illustrative example, a method of wireless communications performed at a UE is provided. The method includes: determining a zone indication type for a groupcast message of the UE, wherein the zone indication type is included in a configured plurality of zone indication types; determining a zone identity (ID) for a current location of the UE, wherein the current location of the UE is within a geographical zone corresponding to the zone ID, and wherein the zone ID is selected from a plurality of zone IDs of the zone indication type; determining range information for the groupcast message, wherein the range information is indicative of a receive area within the geographical zone corresponding to the zone ID; transmitting sidelink information indicative of the zone ID and the range information; and transmitting the groupcast message.

In another illustrative example, a non-transitory computer-readable storage medium is provided that includes instructions stored thereon which, when executed by at least one processor, causes the at least one processor to: determine a zone indication type for a groupcast message of the UE, wherein the zone indication type is included in a configured plurality of zone indication types; determine a zone identity (ID) for a current location of the UE, wherein the current location of the UE is within a geographical zone corresponding to the zone ID, and wherein the zone ID is selected from a plurality of zone IDs of the zone indication type; determine range information for the groupcast message, wherein the range information is indicative of a receive area within the geographical zone corresponding to the zone ID; transmit sidelink information indicative of the zone ID and the range information; and transmit the groupcast message.

In another illustrative example, an apparatus for wireless communications is provided that includes: means for determining a zone indication type for a groupcast message of the UE, wherein the zone indication type is included in a configured plurality of zone indication types; means for determining a zone identity (ID) for a current location of the UE, wherein the current location of the UE is within a geographical zone corresponding to the zone ID, and wherein the zone ID is selected from a plurality of zone IDs of the zone indication type; means for determining range information for the groupcast message, wherein the range information is indicative of a receive area within the geographical zone corresponding to the zone ID; means for transmitting sidelink information indicative of the zone ID and the range information; and means for transmitting the groupcast message.

In another illustrative example, an apparatus of a user equipment (UE) for wireless communications is provided. The apparatus includes at least one memory and at least one processor coupled to the at least one memory, wherein the at least one processor is configured to: receive sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type determine a receive area comprising a portion of the geographical zone corresponding to the zone ID, wherein the receive area is determined based on directional information or angular information included in the range information; and decode a groupcast message received corresponding to the sidelink information, wherein the groupcast message is decoded based on a current location of the first UE being within the receive area.

In another illustrative example, a method of wireless communications performed at a UE is provided. The method includes: receiving sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type determine a receive area comprising a portion of the geographical zone corresponding to the zone ID, wherein the receive area is determined based on directional information or angular information included in the range information; and decoding a groupcast message received corresponding to the sidelink information, wherein the groupcast message is decoded based on a current location of the first UE being within the receive area.

In another illustrative example, a non-transitory computer-readable storage medium is provided that includes instructions stored thereon which, when executed by at least one processor, causes the at least one processor to: receive sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type determine a receive area comprising a portion of the geographical zone corresponding to the zone ID, wherein the receive area is determined based on directional information or angular information included in the range information; and decode a groupcast message received corresponding to the sidelink information, wherein the groupcast message is decoded based on a current location of the first UE being within the receive area.

In another illustrative example, an apparatus for wireless communications is provided that includes: means for receiving sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type determine a receive area comprising a portion of the geographical zone corresponding to the zone ID, wherein the receive area is determined based on directional information or angular information included in the range information; and means for decoding a groupcast message received corresponding to the sidelink information, wherein the groupcast message is decoded based on a current location of the first UE being within the receive area.

In some aspects, the apparatuses or network devices described is, includes, or is part of, a vehicle (e.g., an automobile, truck, etc., or a component or system of an automobile, truck, etc.), a roadside unit (RSU) or other network-enabled infrastructure equipment (e.g., a network-enabled stoplight, etc.), a mobile device (e.g., a mobile telephone or so-called “smart phone” or other mobile device), a network-connected wearable device (e.g., a so-called “smart watch”), an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some examples;

FIG. 2A and FIG. 2B illustrate examples of wireless network structures, in accordance with some examples;

FIG. 2C is a diagram illustrating an example of a disaggregated base station architecture, in accordance with some examples;

FIG. 3 is a diagram illustrating an example of various user equipment (UEs) communicating over direct communication interfaces (e.g., a cellular based PC5 sidelink interface, 802.11p defined DSRC interface, or other direct interface) and wide area network (Uu) interfaces, in accordance with some examples;

FIG. 4 is a block diagram illustrating an example of a computing system of a vehicle, in accordance with some examples;

FIG. 5 is a block diagram illustrating an example of a computing system of a user device, in accordance with some examples;

FIG. 6 is a diagram illustrating an example wireless communications system for implementing UE sidelink synchronization, in accordance with some examples;

FIGS. 7A-7B illustrate example configurations for implementing a UE platoon for sidelink synchronization, in accordance with some examples;

FIG. 8 is a diagram illustrating an example of devices involved in wireless communications (e.g., sidelink communications), in accordance with some examples;

FIGS. 9A-9D are diagrams illustrating examples of sensor-sharing for cooperative and automated driving systems, in accordance with some examples;

FIG. 10 is a diagram illustrating an example of sensor-sharing for cooperative and automated driving systems, in accordance with some examples;

FIG. 11 is a diagram illustrating an example of a system for sensor sharing in wireless communications (e.g., V2X communications), in accordance with examples;

FIG. 12A is a diagram illustrating an example of two-dimensional (2D) distance-based groupcast messaging in wireless communications (e.g., V2X communications), in accordance with some examples;

FIG. 12B is a diagram illustrating an example of a plurality of zones that may be associated with distance-based groupcast messaging in wireless communications (e.g., V2X communications), in accordance with some examples;

FIG. 13A is a diagram illustrating an example of distance-based groupcast messaging for V2X sidelink communications, in accordance with some examples;

FIG. 13B is a diagram illustrating an example of vertical height-based groupcast messaging for V2X sidelink communications, in accordance with some examples;

FIG. 14 is a diagram illustrating an example of a transmission zone and a reception zone for enhanced groupcast for V2X sidelink communications, in accordance with some examples;

FIG. 15 is a flow chart illustrating an example of a process for wireless communications at a first UE, in accordance with some examples;

FIG. 16 is a flow chart illustrating an example of a process for wireless communications at a second UE, in accordance with some examples;

FIG. 17 is a signaling diagram corresponding to a process of wireless communication between a first UE and a second UE, in accordance with some examples; and

FIG. 18 illustrates an example computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

A sidelink may refer to any communication link between client devices (e.g., UEs, STAs, etc.). For example, a sidelink may support device-to-device (D2D) communications, vehicle-to-everything (V2X) and/or vehicle-to-vehicle (V2V) communications, message relaying, discovery signaling, beacon signaling, or any combination of these or other signals transmitted over-the-air from one UE to one or more other UEs. In some examples, sidelink communications may be transmitted using a licensed frequency spectrum or an unlicensed frequency spectrum (e.g., 5 GHz or 6 GHz). As used herein, the term sidelink may refer to 3GPP sidelink (e.g., using a PC5 sidelink interface), Wi-Fi direct communications (e.g., according to a Dedicated Short Range Communication (DSRC) protocol), or using any other direct device-to-device communication protocol.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), infrastructure-to-vehicle (I2V), vehicle-to-network (V2N), and vehicle-to-pedestrian (V2P) communications, which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, roadside units (RSUs), and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), a VRU Awareness message (VAM), and/or other types of vehicle-based messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

As previously mentioned, the V2X technology includes V2V, V2I, and I2V communications, which can also be referred to as peer-to-peer communications. V2V, V2I, and I2V communications allow for vehicles to directly wireless communicate with each other and with V2X-capable infrastructure (e.g., a V2X-capable RSU, a V2X-capable stop light, etc.) while on the road. With V2V, V2I, and I2V communications, vehicles can gain situational awareness by receiving information regarding upcoming road dangers (e.g., unforeseen oncoming vehicles, accidents, and road conditions) from the other vehicles and/or from the V2X-capable infrastructure.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz. (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

Connected vehicles can refer to various vehicle UEs, including a vehicle UE configured for V2X communications (e.g., also referred to as a “V2X UE”). As noted above, a vehicle UE can be used to perform one or more of vehicle (V2V), vehicle-to-infrastructure (V2I), infrastructure-to-vehicle (I2V), vehicle-to-network (V2N), and vehicle-to-pedestrian (V2P) communications, which are all collectively referred to as vehicle-to-everything (V2X) communications.

In some cases, connected vehicles can include or otherwise be associated with a vehicle on-board unit (OBU). The OBU can be used to perform and/or handle communications between the V2X UE (e.g., the connected vehicle) and a mobile network, infrastructure network, surroundings, etc. In some examples, an OBU of a first V2X UE can be used to communicate with corresponding OBUs of various other (e.g., additional) V2X UEs, road-side units (RSUs), and/or vulnerable road users (VRUs, e.g., scooters, smartphones of pedestrians, etc.) using sidelink communications. In some cases, sidelink communications can be used to implement direct communication between V2X or V2V connected vehicles, can be used to implement direction communication between V2X or V2P connected vehicles and pedestrian UEs, etc.

In some examples, V2X wireless communications can include distance-based groupcast messages between V2X UEs (e.g., also referred to as V2X-enabled UEs, V2X-capable UEs, and/or connected vehicles, etc.). For example, V2X distance-based groupcast messages can be used to broadcast information for purposes of situational awareness in which nearby vehicles are the relevant or intended receivers. In some examples, V2X distance-based groupcast can be used to broadcast information from a transmitting UE (e.g., a Tx UE) to a subset of nearby vehicle UEs or other entities (e.g., Rx UEs), for instance in order to share information about traffic conditions, road hazards, etc., among various other events that are only considered relevant to entities within the immediate vicinity of the Tx UE.

In some cases, a distance-based groupcast message can be used to broadcast data from a Tx UE to a group of one or more Rx UEs within a configured distance of the current location of the Tx UE. The current location of the Tx UE can be mapped to a particular zone identity (ID) that corresponds to a unique geographical area (e.g., zone) that encloses the current location of the Tx UE. The mapping between zone IDs to corresponding geographical areas can be based on zone configuration information provided by a network entity associated with the UEs. In some examples, the plurality of zone IDs can be implemented based on mapping a geodesic surface area (e.g., a portion of the surface of the earth) into a plurality of zones that are approximately 5 meter squares.

The configured distance for a V2X distance-based groupcast message can be implemented based on a range requirement value that corresponds to the radius of a circle centered on the current location (e.g., current zone ID) of the Tx UE. V2X-enabled or V2X-capable Rx UEs that are located within the specified minimum radius of the circle are required to correctly decode the packet(s) of the distance-based groupcast message. For example, an Rx UE can calculate a distance between the current Rx UE zone ID and the current Tx UE zone ID, and may be required to decode the V2X distance-based groupcast message if the calculated distance is less than or equal to the configured range requirement value indicated for the V2X distance-based groupcast message.

A two-dimensional (2D) zone indication may provide insufficient granularity to optimize distance-based groupcast transmission to only a specific subset of intended receivers (e.g., candidate Rx UEs for a particular V2X distance-based groupcast message). For instance, existing techniques based on 2D zone indication information cannot be used to specify an area of intended reception using a geometry other than a circle with a radius given by the minimum range require value. Additionally, 2D zone indication information does not indicate a directionality of interest for the intended candidate receivers (e.g., such as in an example where a Tx vehicle UE has data that is only of interest to other vehicles (Rx UEs) moving in the same direction). 2D zone indication information additionally does not indicate height information for intended candidate receivers, and cannot differentiate between candidate Rx UEs on different vertical levels of parking garages or highways, etc.

Systems, apparatuses, processes (also referred to as methods), and computer-readable media (collectively referred to as “systems and techniques”) are described herein for improved and enhanced zone identity (ID) information that can be used to extend V2X distance-based groupcast messages to be indicative of intended or candidate receivers using additional information beyond a two-dimensional (2D) range or distance. For instance, the systems and techniques can be used to provide V2X groupcast messages based on using three-dimensional (3D) zone configuration information indicative of candidate receivers for respective groupcast messages.

In one illustrative example, the systems and techniques can be used to provide 3D zone configuration information for V2X groupcast messages (e.g., including distance-based V2X groupcast messages). The 3D zone configuration information can be indicative of a reception zone corresponding to the candidate receivers of the respective groupcast message. The reception zone may be a two-dimensional (2D) area or may be a 3D area. The 3D zone configuration information can additionally be indicative of one or more of directional information and/or height information that can be used by candidate receiver UEs to determine the reception zone for a respective groupcast message.

In some aspects, the systems and techniques can be used to implement 3D zone indications for a Tx UE and/or for one or more intended Rx UEs of a V2X groupcast message. For instance, the systems and techniques can implement 3D zone indications for V2X groupcast messages based on configuring the UEs (e.g., at least the Tx UE and the Rx UEs) with information indicative of a 3D zone indication type and a 3D zone indication mode. In some aspects, the systems and techniques can be used to implement directional zone indications, for instance based on configuring the UEs with a directional zone indication type and a directional zone indication mode. In some aspects, the systems and techniques can be used to indicate height-based zone indications, for instance based on configuring the UEs with a height-based zone indication type and a height-based zone indication mode. In some examples, the systems and techniques can be used to indicate lane and/or roadway based zone indications for V2X UEs and/or V2X-capable UEs, for instance based on configuring the UEs with a lane-based or roadway-based zone indication type and zone indication mode (respectively).

In some examples, the intended receivers (e.g., Rx UEs) for a V2X groupcast message can be determined based on the enhanced zone indication information of the Tx UE, where the Tx UE enhanced zone indication information includes a 2D or 3D enhanced zone corresponding to the Tx UE, and additionally includes range information indicative of a subset (e.g., a sub-area) of the Tx UE enhanced zone. For example, the range information can be indicative of a non-circular area of the intended Rx UEs, within the Tx UE zone. In another example, the range information can be indicative of one or more included height value ranges and/or one or more excluded height value ranges of the intended Rx UEs.

In some aspects, the included or excluded height value ranges of the intended Rx UEs can be combined with 2D area information of the intended Rx UEs, to implement a 3D zone indication configuration for the reception area of the intended Rx UEs associated with a respective V2X groupcast message. The 2D area information can correspond to a circular area or can correspond to a non-circular area (e.g., areas having non-circular geometries). In some examples, the range information can be indicative of directional information of the intended Rx UEs, where the directional information is indicated relative to the Tx UE associated with the V2X groupcast message.

For instance, the directional information can identify Rx UEs in front of the Tx UE, moving in the same direction as the Tx UE, etc., as the intended receivers of a V2X groupcast message transmitted by the Tx UE. The directional information can be used to identify Rx UEs included in the intended receivers of a V2X groupcast message, can be used to identify Rx UEs excluded from the intended receivers of a V2X groupcast message, or a combination of the two.

In some aspects, the systems and techniques can additionally be used to implement reception zone determination and indication, where the area of intended Rx UEs for a V2X groupcast message is the intersection of the transmission zone indication (e.g., Tx UE zone ID) and the reception zone indication.

Additional aspects of the present disclosure are described below with reference to the figures.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), a network-connected wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

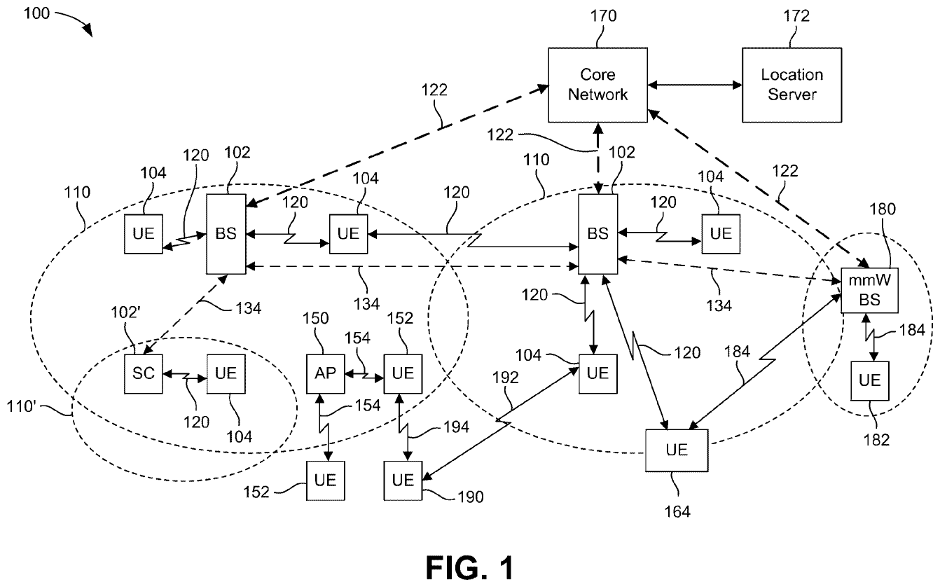

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

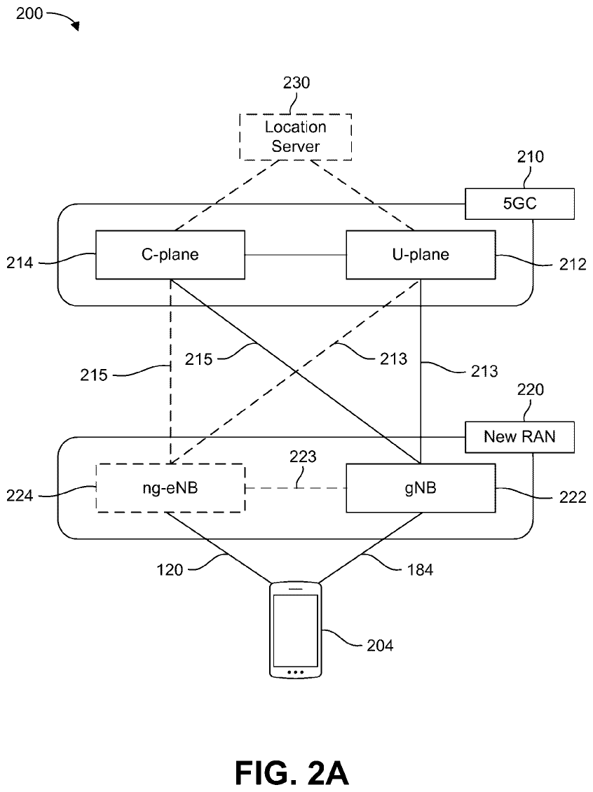

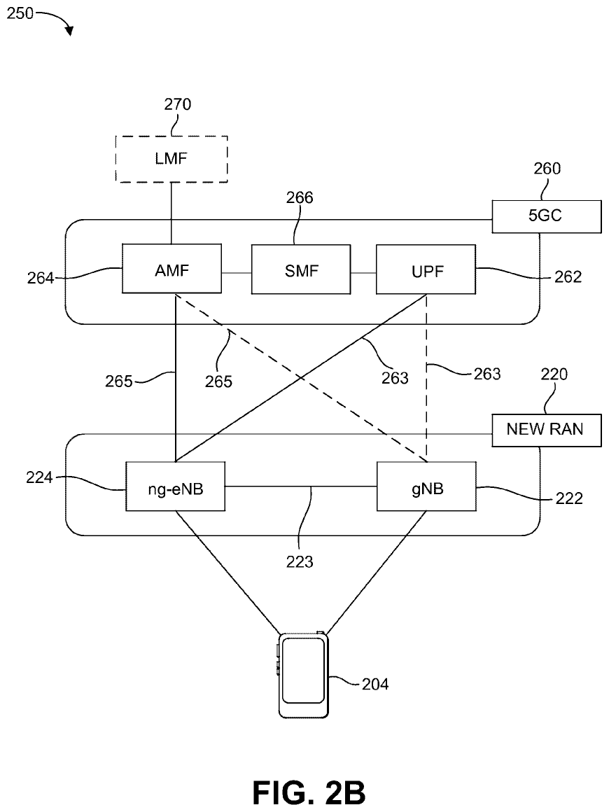

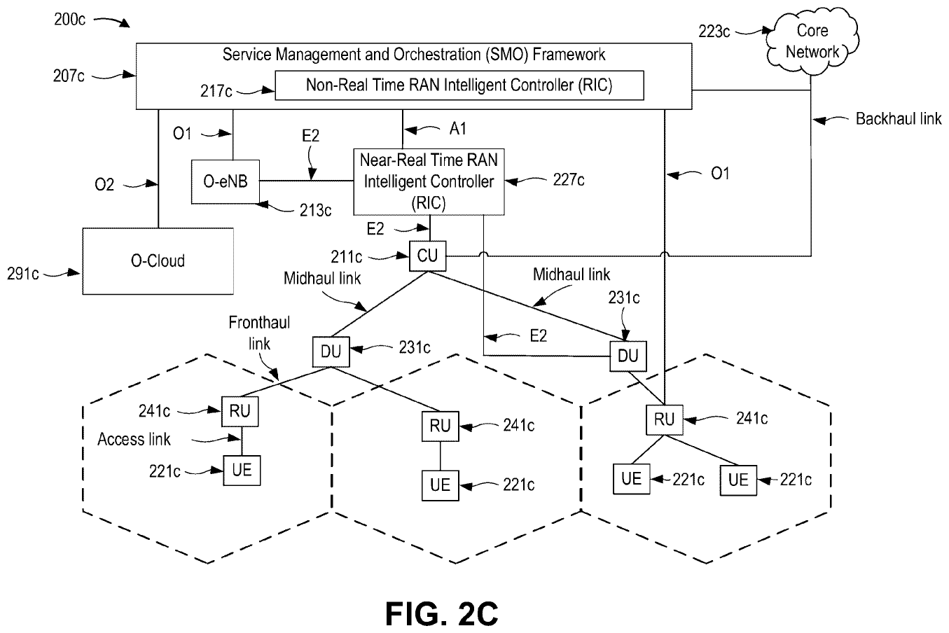

According to various aspects, FIG. 2A illustrates an example wireless network structure 200. For example, a 5GC 210 (also referred to as a Next Generation Core (NGC)) may be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1).

In some aspects, wireless network structure 200 may include location server 230, which may be in communication with the 5GC 210 to provide location assistance for UEs 204. The location server 230 may be implemented as a plurality of separate servers (e.g., physically separate servers, different software modules on a single server, different software modules spread across multiple physical servers, etc.), or alternately may each correspond to a single server. The location server 230 may be configured to support one or more location services for UEs 204 that may connect to the location server 230 via the core network, 5GC 210, and/or via the Internet (not illustrated). Further, the location server 230 may be integrated into a component of the core network, or alternatively may be external to the core network. In some examples, the location server 230 may be operated by a carrier or provider of the 5GC 210, a third party, an original equipment manufacturer (OEM), or other party. In some cases, multiple location servers may be provided, such as a location server for the carrier, a location server for an OEM of a particular device, and/or other location servers. In such cases, location assistance data may be received from the location server of the carrier and other assistance data may be received from the location server of the OEM.

According to various aspects, FIG. 2B illustrates another example wireless network structure 250. In some examples, 5GC 260 may be viewed functionally as control plane functions, provided by an access and mobility management function (AMF) 264, and user plane functions, provided by a user plane function (UPF) 262, which operate cooperatively to form the core network (e.g., 5GC 260). User plane interface 263 and control plane interface 265 connect the ng-eNB 224 to the 5GC 260 and specifically to UPF 262 and AMF 264, respectively. In some examples, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 over the N2 interface and with the UPF 262 over the N3 interface.

The functions of the AMF 264 may include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 may also interact with an authentication server function (AUSF) (not shown) and the UE 204, and may receive an intermediate key established as a result of the UE 204 authentication process.

In the case of authentication based on a UMTS (universal mobile telecommunications system) subscriber identity module (USIM), the AMF 264 may retrieve the security material from the AUSF. The functions of the AMF 264 may also include security context management (SCM). The SCM may receive a key from the SEAF that it may use to derive access-network specific keys. The functionality of the AMF 264 may also include location services management for regulatory services, transport for location services messages between the UE 204 and a location management function (LMF) 270 (which acts as a location server 230), transport for location services messages between the New RAN 220 and the LMF 270, evolved packet system (EPS) bearer identifier allocation for interworking with the EPS, and UE 204 mobility event notification. In addition, the AMF 264 may also support functionalities for non-3GPP access networks.

In some cases, UPF 262 may perform functions that include serving as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink and/or downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. In some aspects, UPF 262 may also support transfer of location services messages over a user plane between the UE 204 and a location server, such as a secure user plane location (SUPL) location platform (SLP), not shown in FIG. 2B.

In some examples, the functions of SMF 266 may include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 may be referred to as the N11 interface.

In some aspects, wireless network structure 250 may include an LMF 270, which may be in communication with the 5GC 260 to provide location assistance for UEs 204. The LMF 270 may be implemented as a plurality of separate servers (e.g., physically separate servers, different software modules on a single server, different software modules spread across multiple physical servers, etc.), or alternately may each correspond to a single server. The LMF 270 may be configured to support one or more location services for UEs 204 that may connect to the LMF 270 via the core network, 5GC 260, and/or via the Internet (not illustrated). The SLP may support similar functions to the LMF 270, but whereas the LMF 270 may communicate with the AMF 264, New RAN 220, and UEs 204 over a control plane (e.g., using interfaces and protocols intended to convey signaling messages and not voice or data), the SLP may communicate with UEs 204 and external clients (not shown in FIG. 2B) over a user plane (e.g., using protocols intended to carry voice and/or data like the transmission control protocol (TCP) and/or IP).

In some cases, LMF 270 and/or the SLP may be integrated with a base station, such as the gNB 222 and/or the ng-eNB 224. When integrated with the gNB 222 and/or the ng-eNB 224, the LMF 270 and/or the SLP may be referred to as a “location management component,” or “LMC.” As used herein, references to LMF 270 and SLP include both the case in which the LMF 270 and the SLP are components of the core network (e.g., 5GC 260) and the case in which the LMF 270 and the SLP are components of a base station.

As described above, wireless communications systems support communication among multiple UEs. In various examples, wireless communications systems may be configured to support device-to-device (D2D) communication and/or vehicle-to-everything (V2X) communication. V2X may also be referred to as Cellular V2X (C-V2X). V2X communications may be performed using any radio access technology, such as LTE, 5G, WLAN, or other communication protocol. In some examples, UEs may transmit and receive V2X messages to and from other UEs, road side units (RSUs), and/or other devices over a direct communications link or interface (e.g., a PC5 or sidelink interface, an 802.11p DSRC interface, and/or other communications interface) and/or via the network (e.g., an eNB, a WiFi AP, and/or other network entity). The communications may be performed using resources assigned by the network (e.g., an eNB or other network device), resources pre-configured for V2X use, and/or using resources determined by the UEs (e.g., using clear channel assessment (CCA) with respect to resources of an 802.11 network).

V2X communications may include communications between vehicles (e.g., vehicle-to-vehicle (V2V)), communications between vehicles and infrastructure (e.g., vehicle-to-infrastructure (V2I)), communications between vehicles and pedestrians (e.g., vehicle-to-pedestrian (V2P)), and/or communications between vehicles and network severs (vehicle-to-network (V2N)). For V2V, V2P, and V2I communications, data packets may be sent directly (e.g., using a PC5 interface, using an 802.11 DSRC interface, etc.) between vehicles without going through the network, eNB, or gNB. V2X-enabled vehicles, for instance, may use a short-range direct-communication mode that provides 360° non line-of-sight (NLOS) awareness, complementing onboard line-of-sight (LOS) sensors, such as cameras, radio detection and ranging (RADAR), Light Detection and Ranging (LIDAR), among other sensors. The combination of wireless technology and onboard sensors enables V2X vehicles to visually observe, hear, and/or anticipate potential driving hazards (e.g., at blind intersections, in poor weather conditions, and/or in other scenarios). V2X vehicles may also understand alerts or notifications from other V2X-enabled vehicles (based on V2V communications), from infrastructure systems (based on V2I communications), and from user devices (based on V2P communications). Infrastructure systems may include roads, stop lights, road signs, bridges, toll booths, and/or other infrastructure systems that may communicate with vehicles using V2I messaging.

Depending on the desired implementation, sidelink communications may be performed according to 3GPP communication protocols sidelink (e.g., using a PC5 sidelink interface according to LTE, 5G, etc.), Wi-Fi direct communication protocols (e.g., DSRC protocol), or using any other device-to-device communication protocol. In some examples, sidelink communication may be performed using one or more Unlicensed National Information Infrastructure (U-NII) bands. For instance, sidelink communications may be performed in bands corresponding to the U-NII-4 band (5.850-5.925 GHZ), the U-NII-5 band (5.925-6.425 GHZ), the U-NII-6 band (6.425-6.525 GHz), the U-NII-7 band (6.525-6.875 GHZ), the U-NII-8 band (6.875-7.125 GHZ), or any other frequency band that may be suitable for performing sidelink communications.

FIG. 2C is a diagram illustrating an example of a disaggregated base station architecture, which may be employed by the disclosed system for enhanced VRU prediction through server-based processing (e.g., cloud-based processing using one or more servers), in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2C shows a diagram illustrating an example disaggregated base station 200c architecture. The disaggregated base station 200c architecture may include one or more central units (CUs) 211c that can communicate directly with a core network 223c via a backhaul link, or indirectly with the core network 223c through one or more disaggregated base station units (such as a Near-Real Time (Near-RT) RAN Intelligent Controller (RIC) 227c via an E2 link, or a Non-Real Time (Non-RT) RIC 217 associated with a Service Management and Orchestration (SMO) Framework 207c, or both). A CU 211c may communicate with one or more distributed units (DUs) 231c via respective midhaul links, such as an F1 interface. The DUs 231c may communicate with one or more radio units (RUs) 241c via respective fronthaul links. The RUs 241c may communicate with respective UEs 221c via one or more RF access links. In some implementations, the UE 221c may be simultaneously served by multiple RUs 241c.

Each of the units, e.g., the CUS 211c, the DUs 231c, the RUs 241c, as well as the Near-RT RICs 227c, the Non-RT RICs 217c and the SMO Framework 207c, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211c may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211c. The CU 211c may be configured to handle user plane functionality (e.g., Central Unit—User Plane (CU-UP)), control plane functionality (e.g., Central Unit—Control Plane (CU-CP)), or a combination thereof. In some implementations, the CU 211c can be logically split into one or more CU-UP units and one or more CU-CP units. The CU-UP unit can communicate bidirectionally with the CU-CP unit via an interface, such as the E1 interface when implemented in an O-RAN configuration. The CU 211c can be implemented to communicate with the DU 131c, as necessary, for network control and signaling.

The DU 231c may correspond to a logical unit that includes one or more base station functions to control the operation of one or more RUs 241c. In some aspects, the DU 231c may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 231c may further host one or more low PHY layers. Each layer (or module) can be implemented with an interface configured to communicate signals with other layers (and modules) hosted by the DU 231c, or with the control functions hosted by the CU 211c.

Lower-layer functionality can be implemented by one or more RUs 241c. In some deployments, an RU 241c, controlled by a DU 231c, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 241c can be implemented to handle over the air (OTA) communication with one or more UEs 221c. In some implementations, real-time and non-real-time aspects of control and user plane communication with the RU(s) 241c can be controlled by the corresponding DU 231c. In some scenarios, this configuration can enable the DU(s) 231c and the CU 211c to be implemented in a server-based (e.g., cloud-based) RAN architecture, such as a vRAN architecture.

The SMO Framework 207c may be configured to support RAN deployment and provisioning of non-virtualized and virtualized network elements. For non-virtualized network elements, the SMO Framework 207c may be configured to support the deployment of dedicated physical resources for RAN coverage requirements which may be managed via an operations and maintenance interface (such as an O1 interface). For virtualized network elements, the SMO Framework 207c may be configured to interact with a cloud computing platform (such as an open cloud (O-Cloud) 291c) to perform network element life cycle management (such as to instantiate virtualized network elements) via a cloud computing platform interface (such as an O2 interface). Such virtualized network elements can include, but are not limited to, CUs 211c, DUs 231c, RUs 241c and Near-RT RICs 227c. In some implementations, the SMO Framework 207c can communicate with a hardware aspect of a 4G RAN, such as an open eNB (O-eNB) 213c, via an O1 interface. Additionally, in some implementations, the SMO Framework 207c can communicate directly with one or more RUs 241c via an O1 interface. The SMO Framework 207c also may include a Non-RT RIC 217c configured to support functionality of the SMO Framework 207c.

The Non-RT RIC 217c may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227c. The Non-RT RIC 217c may be coupled to or communicate with (such as via an A1 interface) the Near-RT RIC 227c. The Near-RT RIC 227c may be configured to include a logical function that enables near-real-time control and optimization of RAN elements and resources via data collection and actions over an interface (such as via an E2 interface) connecting one or more CUs 211c, one or more DUs 231c, or both, as well as an O-eNB 213c, with the Near-RT RIC 227c.

In some implementations, to generate AI/ML models to be deployed in the Near-RT RIC 227c, the Non-RT RIC 217c may receive parameters or external enrichment information from external servers. Such information may be utilized by the Near-RT RIC 227c and may be received at the SMO Framework 207c or the Non-RT RIC 217c from non-network data sources or from network functions. In some examples, the Non-RT RIC 217c or the Near-RT RIC 227c may be configured to tune RAN behavior or performance. For example, the Non-RT RIC 217c may monitor long-term trends and patterns for performance and employ AI/ML models to perform corrective actions through the SMO Framework 207c (such as reconfiguration via O1) or via creation of RAN management policies (such as A1 policies).

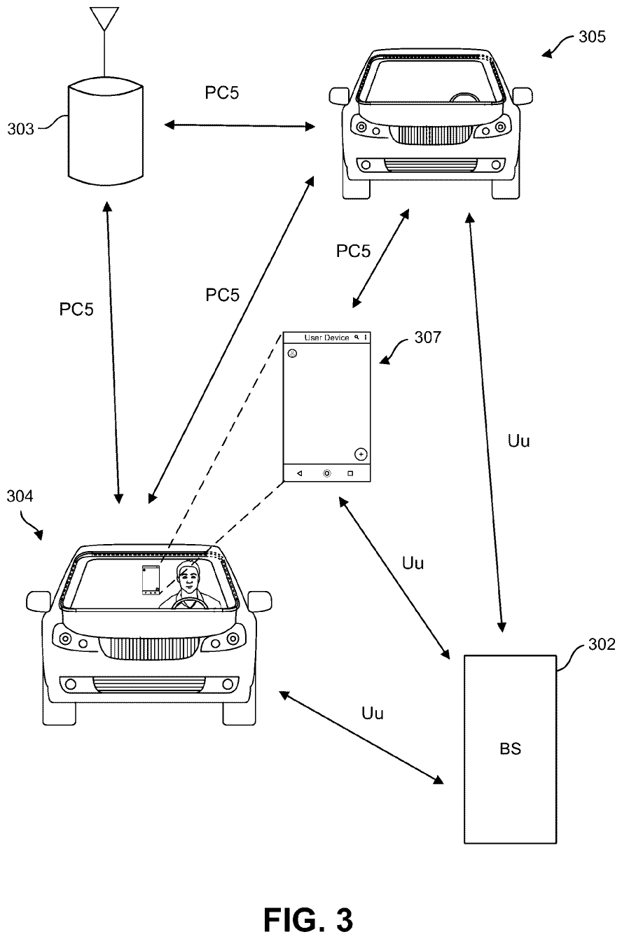

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 (or UE) communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

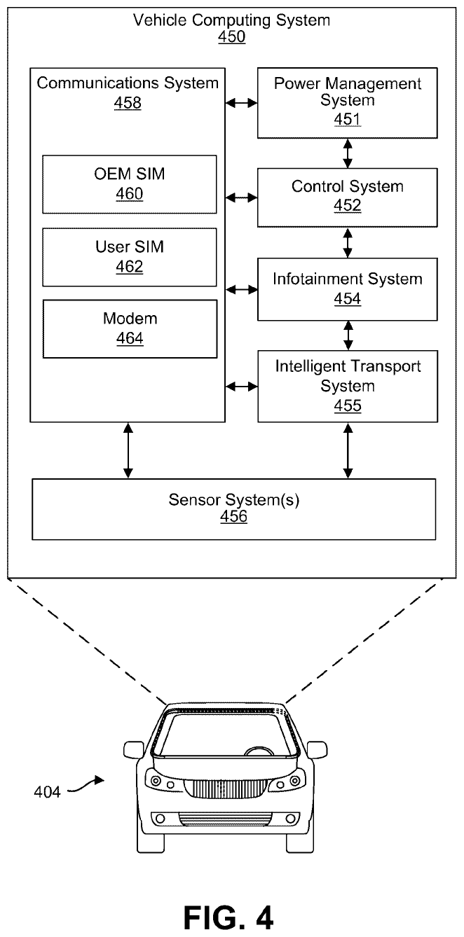

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (eCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

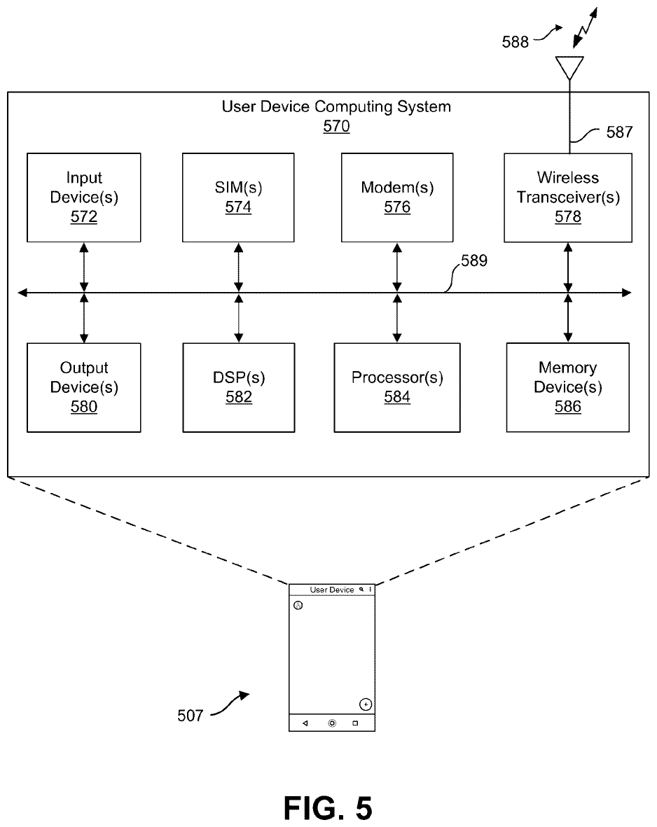

FIG. 5 illustrates an example of a computing system 570 of a user device 507 (or UE). The user device 507 is an example of a UE that can be used by an end-user. For example, the user device 507 can include a mobile phone, router, tablet computer, laptop computer, tracking device, a network-connected wearable device (e.g., a smart watch, glasses, an XR device, etc.), Internet of Things (IoT) device, and/or other device used by a user to communicate over a wireless communications network. The computing system 570 includes software and hardware components that can be electrically or communicatively coupled via a bus 589 (or may otherwise be in communication, as appropriate). For example, the computing system 570 includes one or more processors 584. The one or more processors 584 can include one or more CPUs, ASICs, FPGAS, APs, GPUs, VPUs, NSPs, microcontrollers, dedicated hardware, any combination thereof, and/or other processing device or system. The bus 589 can be used by the one or more processors 584 to communicate between cores and/or with the one or more memory devices 586.

The computing system 570 may also include one or more memory devices 586, one or more digital signal processors (DSPs) 582, one or more SIMs 574, one or more modems 576, one or more wireless transceivers 578, an antenna 587, one or more input devices 572 (e.g., a camera, a mouse, a keyboard, a touch sensitive screen, a touch pad, a keypad, a microphone, and/or the like), and one or more output devices 580 (e.g., a display, a speaker, a printer, and/or the like).

The one or more wireless transceivers 578 can receive wireless signals (e.g., signal 588) via antenna 587 from one or more other devices, such as other user devices, vehicles (e.g., vehicle 404 of FIG. 4 described above), network devices (e.g., base stations such as eNBs and/or gNBs, WiFi routers, etc.), cloud networks, and/or the like. In some examples, the computing system 570 can include multiple antennae. The wireless signal 588 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 578 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 588 into a baseband or intermediate frequency and can convert the RF signals to the digital domain.

In some cases, the computing system 570 can include a coding-decoding device (or CODEC) configured to encode and/or decode data transmitted and/or received using the one or more wireless transceivers 578. In some cases, the computing system 570 can include an encryption-decryption device or component configured to encrypt and/or decrypt data (e.g., according to the AES and/or DES standard) transmitted and/or received by the one or more wireless transceivers 578.

The one or more SIMs 574 can each securely store an IMSI number and related key assigned to the user of the user device 507. As noted above, the IMSI and key can be used to identify and authenticate the subscriber when accessing a network provided by a network service provider or operator associated with the one or more SIMs 574. The one or more modems 576 can modulate one or more signals to encode information for transmission using the one or more wireless transceivers 578. The one or more modems 576 can also demodulate signals received by the one or more wireless transceivers 578 in order to decode the transmitted information. In some examples, the one or more modems 576 can include a 4G (or LTE) modem, a 5G (or NR) modem, a modem configured for V2X communications, and/or other types of modems. The one or more modems 576 and the one or more wireless transceivers 578 can be used for communicating data for the one or more SIMs 574.

The computing system 570 can also include (and/or be in communication with) one or more non-transitory machine-readable storage media or storage devices (e.g., one or more memory devices 586), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 586 and executed by the one or more processor(s) 584 and/or the one or more DSPs 582. The computing system 570 can also include software elements (e.g., located within the one or more memory devices 586), including, for example, an operating system, device drivers, executable libraries, and/or other code, such as one or more application programs, which may comprise computer programs implementing the functions provided by various aspects, and/or may be designed to implement methods and/or configure systems, as described herein.

FIG. 6 is a diagram illustrating an example wireless communications system 600 for configuring transmission of a sidelink synchronization signal by a wireless device. In some aspects, the system 600 may include one or more user equipment (UE) devices such as UE 602 and UE 604. As noted above, a UE device (e.g., UE 602 and/or UE 604) may include any wireless communication device (e.g., a mobile phone, router, tablet computer, laptop computer, tracking device, wearable device (e.g., smart watch, glasses, an extended reality (XR) device such as a virtual reality (VR) headset, an augmented reality (AR) headset or glasses, or a mixed reality (MR) headset, etc.), vehicle (e.g., automobile, motorcycle, bicycle, etc.), Internet of Things (IoT) device, etc.) used by a user to communicate over a wireless communications network.

In some examples, system 600 may include one or more base stations. For instance, system 600 can include base station 610, base station 612, and base station 614. In some cases, base station 610, base station 612, and/or base station 614 can be associated with UE 602 (e.g., UE 602 may communicate with base station 610 using a network (Uu) interface). In some aspects, one or more of the base stations (e.g., base station 610, base station 612, and/or base station 614) can communicate with location server 616 (e.g., configured to implement LMF 270).

In some cases, UE 602 and UE 604 can be configured to communicate using sidelink communications (e.g., PC5, DSRC, and/or Uu-based sidelink communications, etc.). In some aspects, a UE that receives a sidelink communication (e.g., UE 602 and/or UE 604) can use a sidelink synchronization signal (SLSS) to synchronize to the transmitting UE to properly demodulate and/or decode received data. In some cases, the SLSS can include a primary sidelink synchronization signal (P-SSS) and/or a secondary sidelink synchronization signal (S-SSS). In some aspects, SLSS (e.g., the P-SSS and/or the S-SSS) can be included in a sidelink synchronization signal block (S-SSB). In some examples, the S-SSB can be transmitted as part of a Physical Sidelink Broadcast Channel (PSBCH).

In some cases, the source of the SLSS for a UE device can be a Global Navigation Satellite System (GNSS) signal, a base station signal, a signal from another UE, and/or an internal clock signal (e.g., clock generated by the UE device. In some examples, UE 602 may prioritize using the GNSS signal received from satellite 608 as the source of the SLSS. In some aspects, if a GNSS signal is not available, UE 602 may utilize a downlink signal from a base station (e.g., base station 610, base station 612, and/or base station 614) as the source of the SLSS. In some examples, if UE 602 cannot receive a GNSS signal or a base station signal, UE 602 may utilize a signal from another UE as the source of the SLSS. In some cases, if no external source (e.g., GNSS satellite, base station, or other UE) for the SLSS is available, UE 602 may utilize an internal clock as the source of the SLSS.

In some cases, a UE device may be located within a geographic area where the UE device is unable to receive a GNSS signal and/or a base station signal for use as a sidelink synchronization source. As illustrated, UE 604 is located within shielded geographic area 606. In some cases, shielded geographic area 606 may correspond to a geographic area in which GNSS signal quality and/or base station signal quality is deficient (e.g., not accessible or below a threshold signal quality). Illustrative examples of shielded geographic area 606 can include a tunnel, an urban canyon, a forest, a parking garage, and/or any other geographic area in which GNSS signal quality and/or base station signal quality is deficient.

In some examples, a base station (e.g., base station 610, base station 612, and/or base station 614) can instruct UE 602 to transmit SLSS 618 based the location of UE 602 relative to shielded geographic area 606. For example, location server 616 (e.g., LMF 270) can calculate the position of UE 602 (e.g., based on positioning reference signals, UL/DL measurements, etc.). In some cases, location server 616 can determine the position of UE 602 within 50 meters (m) of accuracy. In some aspects, location server 616 can determine the position of UE 602 within 10 m of accuracy.

In some aspects, location server 616 can send the location data associated with UE 602 to one or more base stations that are in proximity of shielded geographic area 606. In some cases, a base station can use the location data to determine that UE 602 is in close proximity to shielded geographic area 606. For example, location server 616 can send the location of UE 602 to base station 614 and base station 614 can use the location data to determine the proximity of UE 602 to shielded geographic area 606. In some cases, base station 614 can instruct UE 602 to transmit SLSS 618 when UE 602 is near shielded geographic area 606. In some example, base station 614 can instruct UE 602 to transmit SLSS 618 when UE 602 is within a threshold distance of shielded geographic area 606. For instance, base station 614 can instruct UE 602 to transmit SLSS 618 when UE 602 is within 1000 m of shielded geographic area 606.

In some examples, the location server 616 may use the position of UE 602 to determine a location of UE 602 on a map. For example, location server 616 may access map data and determine the proximity of UE 602 to shielded geographic area 606. In some cases, location server 616 may send a message to a base station (e.g., base station 614) to instruct UE 602 to transmit SLSS 618. In some aspects, multi-access edge computing (MEC) may be used to implement UE device location functions (e.g., performed by LMF 270). In some configurations, MEC can be utilized to reduce latency in signaling a UE device to transmit a sidelink synchronization signal.

In some aspects, a base station (e.g., base station 610, base station 612, and/or base station 614) can instruct UE 602 to transmit SLSS 618 based on a geofence configuration corresponding to geographic areas associated with poor signal quality (e.g., shielded geographic area 606). For example, base station 614 can instruct UE 602 to transmit SLSS 618 based on a proximity to shielded geographic area 606 (e.g., based on the location of base station 614). In some examples, a base station may instruct all associated UE devices to transmit a sidelink synchronization signal. In some cases, a base station may instruct all associated UE devices within a zone or region to transmit a sidelink synchronization signal. In some instances, a base station may use UE location data (e.g., received from location server 616) to select UE devices that are to transmit a sidelink synchronization signal. In some cases, a geofence configuration of shielded geographic area 606 can be based on a cell identifier. For instance, a footprint or geofence corresponding to shielded geographic area 606 can correspond to one or more base station identifiers corresponding to base station 610, base station 612, and/or base station 614. In some aspects, the identifier(s) associated with a geofence may include a physical cell identifier (PCI), a virtual cell identifier (VCI), and/or a cell global identifier (CGI). In some cases, the base station identifiers for implementing geofencing of shielded geographic area 606 can be based on cell handover and/or cell reselection configurations. In some aspects, base station geofencing (e.g., to identify shielded geographic area 606) can be configured per network operator (e.g., configured per public land mobile network (PLMN)).

In some examples, UE 602 and UE 604 may use sidelink communications to associate and form a UE platoon (e.g., a cluster of associated UE devices). In some cases, a UE platoon can include a platoon leader that is configured to transmit a sidelink synchronization signal to the UE devices in the UE platoon. In some examples, UE devices in a UE platoon may designate a platoon leader based on a position of the UE devices within the platoon. In some cases, the platoon leader (e.g., sidelink synchronization source for the platoon) may be selected to be the last UE device in the platoon to lose GNSS and/or base station connectivity (e.g., UE device at back of platoon). In one illustrative example, UE 602 can be designated as the platoon leader configured to transmit SLSS 618 based on the position of UE 602 at the back of the platoon (e.g., UE 602 will enter shielded geographic area 606 after UE 604).

In some aspects, UE 602 and/or UE 604 may initiate formation of a UE platoon in anticipation of entering shielded geographic area 606. In some examples, two or more UE devices may form a UE platoon based on parameters that can include UE locality (e.g., distance between UE devices), direction of travel, lane position (e.g., UE devices in same lane or adjacent lanes), speed of travel, UE capability (e.g., UE sidelink configuration, UE capability to propagate SLSS, UE capability to be configured as independent SLSS source, etc.), and/or any other UE parameter, attribute, or metric.

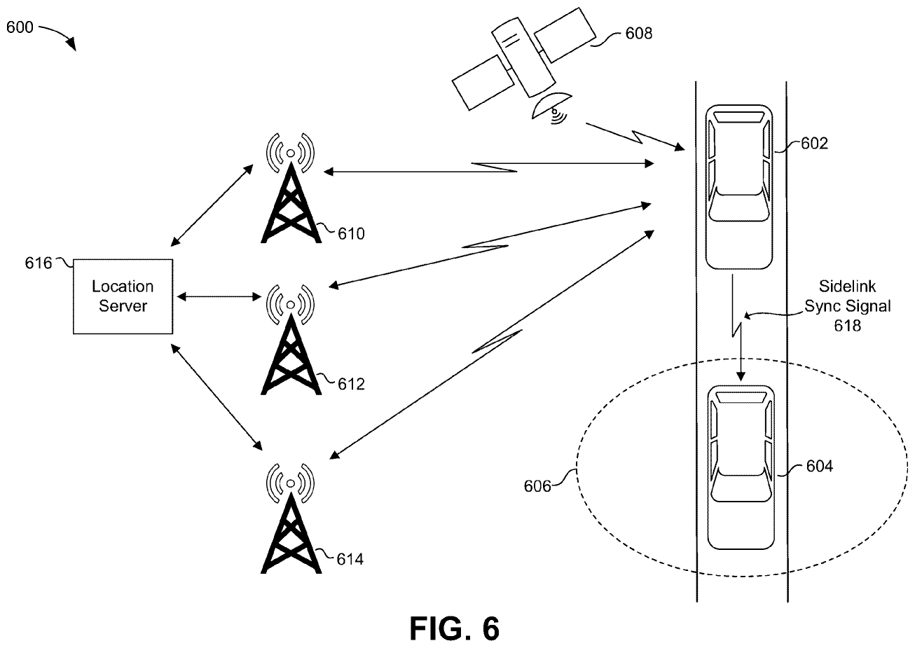

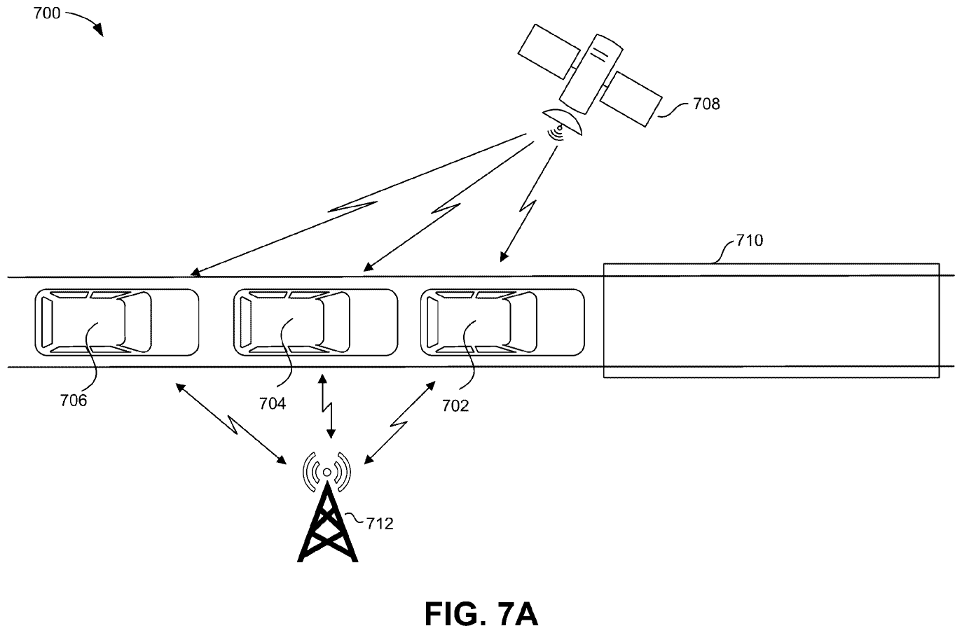

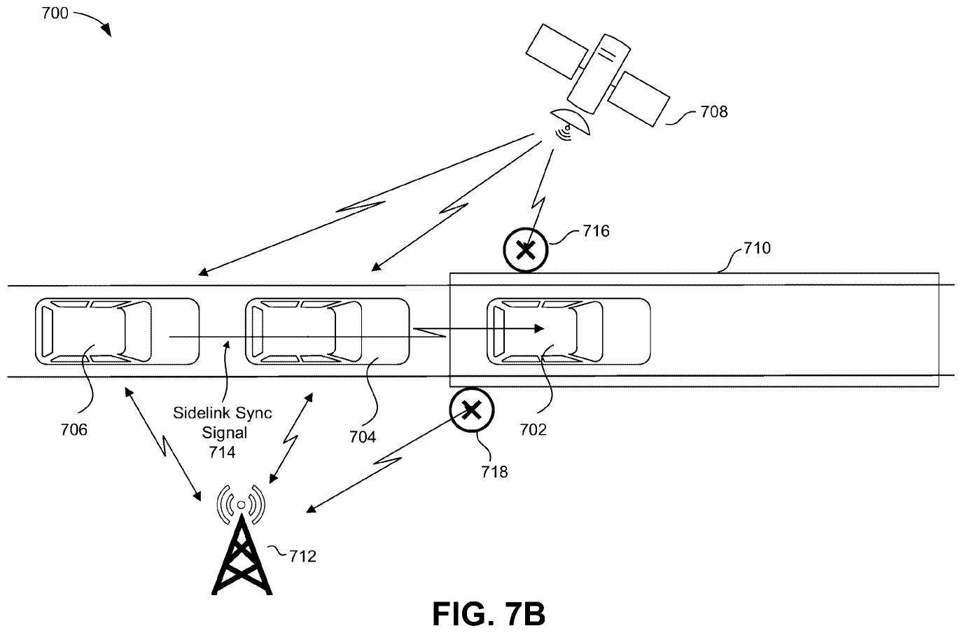

FIG. 7A illustrates a system 700 that can be used to implementing a UE platoon for synchronizing sidelink communications. In some examples, system 700 can include UE 702, UE 704, and UE 706 that can each receive a GNSS signal from satellite 708. In some aspects, the GNSS signal from satellite 708 can be used as a sidelink synchronization signal (SLSS). In some examples, UE 702, UE 704, and UE 706 can communicate using sidelink communications and use the GNSS signal from satellite 708 as a SLSS to demodulate received data. In some cases, each UE device (e.g., UE 702, UE 704, and UE 706) in system 700 can be associated with base station 712.

In some aspects, system 700 can include a tunnel 710 that is associated with a deficient GNSS signal and/or a deficient base station signal. In some examples, tunnel 710 can correspond to any shielded geographic area (e.g., parking garage, urban canyon, forest, etc.) in which a UE device may not receive a suitable GNSS signal and/or a suitable base station signal. In some cases, UE 702 may initiate formation of a UE platoon prior to entering tunnel 710. In some examples, UE 702 can send a sidelink communication to UE 704 and/or UE 706 to initiate formation of a UE platoon. In some aspects, UE 702, UE 704, and UE 706 may form a UE platoon based on parameters that can include UE locality (e.g., distance between UE devices), direction of travel, lane position, speed of travel, and/or UE capability. For example, UE 702, UE 704, and UE 706 can form a UE platoon in response to determining that each of the respective UE devices is travelling in a same traffic lane. In another example, UE 702, UE 704, and UE 706 can form a UE platoon in response to determining that each of the respective UE devices is travelling within 5 miles-per-hour (mph) of each other. In another example, UE 702, UE 704, and UE 706 can form a UE platoon in response to determining that each of the respective UE devices is within 50 m of each other. In another example, UE 702, UE 704, and UE 706 can form a UE platoon in response to determining that each of the respective UE devices has the capability to be configured as a sidelink synchronization signal source.

In some aspects, UE 702, UE 704, and UE 706 can send sidelink communications to determine the respective position of each UE device within the UE platoon. For example, UE 702 can be identified as the “head” of the UE platoon and UE 706 can be identified as the “tail” of the UE platoon. In some cases, the position of a UE device within the UE platoon can be used to determine a platoon leader. In some instances, the platoon leader can correspond to the UE device that will transmit the sidelink synchronization signal (e.g., the UE device that will be configured as the sidelink synchronization source).

In some cases, the platoon leader (e.g., sidelink synchronization source for the platoon) may be selected to be the last UE device in the platoon to lose GNSS and/or base station connectivity (e.g., UE device at back of platoon). In one illustrative example, UE 706 can be designated as the platoon leader configured to transmit a sidelink synchronization signal to UE 702 and UE 704 based on the position of UE 706 at the back of the platoon (e.g., UE 706 will be last to enter tunnel 710). In another example, the platoon leader may be selected to be a UE device that is in the center of the UE platoon. For instance, UE 704 can be selected as the platoon leader in order to minimize the transmission distance of the sidelink synchronization signal (e.g., from UE 704 to UE 706 and from UE 704 to UE 702).

In some cases, the designation of the platoon leader can be changed dynamically based on a change in the relative positions of the UE devices. For instance, UE 704 can be designated as the platoon leader if UE 704 positioned as the last device in the UE platoon (e.g., UE 704 is passed by UE 706 prior to entering tunnel 710). In another example, UE 702 can be designated as the platoon leader if UE 702 is passed by UE 704 and UE 706 prior to entering tunnel 710. In some examples, UE devices may join or leave the UE platoon at different times. In some cases, changes in the makeup of the UE platoon may result in a change of the platoon leader.

In some aspects, the formation of the UE platoon (e.g., arrangement and/or positioning of UE devices within the UE platoon) can be configured based on factors such as the number of UE devices in the UE platoon, the number of traffic lanes, the length of the tunnel, etc. For example, a UE platoon that includes six UE devices can have a 6×1 formation (e.g., six vehicles in one lane) or a 3×2 formation (e.g., three vehicles in each of two parallel lanes). In some examples, the formation of the UE platoon can be configured to provide efficient clustering of UE devices in the UE platoon. In some cases, efficient clustering of UE devices can correspond to a platoon formation where the UE devices are in closer proximity of each other. In some examples, efficient clustering of UE devices can correspond to a platoon formation that minimizes the transmission distance between the platoon leader (e.g., transmitting the sidelink synchronization signal) and the UE device that is furthest from the platoon leader.

In some aspects, the formation of the UE platoon can be configured based on the length of a tunnel. For example, the length of a column (e.g., UE devices in a line in the direction of travel) in the UE platoon can be relative to the length of the tunnel (e.g., a shorter tunnel can correspond to a shorter column length). In some examples, the formation of the UE platoon can be dynamically updated. For instance, the formation of the UE platoon may change based on a change in the number of UE devices in the UE platoon, a change in the number of traffic lanes available, traffic conditions, transmission signal quality, etc.

FIG. 7B illustrates a configuration of system 700 that can follow the configuration illustrated in FIG. 7A. In some aspects, UE 702 can be positioned inside of tunnel 710 while UE 704 and UE 706 are positioned outside of tunnel 710. In some examples, UE 704 and UE 706 can receive a GNSS signal from satellite 708. In some cases, UE 704 and UE 706 can be associated with base station 712. In some examples, UE 702 may not be able to receive a GNSS signal (illustrated by ‘X’ 716) from satellite 708 while inside of tunnel 710. In some cases, UE 702 may not be able to receive a base station signal (illustrated by ‘X’ 718) from base station 712 while inside of tunnel 710.

In some aspects, UE 706 can be configured as the platoon leader for the UE platoon that includes UE 702, UE 704, and UE 706. In some cases, UE 706 can transmit sidelink synchronization signal (SLSS) 714 that is based on GNSS signal from satellite 708. In some examples, UE 702 can receive SLSS 714 from UE 706 and use SLSS 714 to demodulate sidelink communications from UE 704 and/or UE 706. In some cases, UE 704 can continue to use the GNSS signal from satellite 708 as a SLSS.

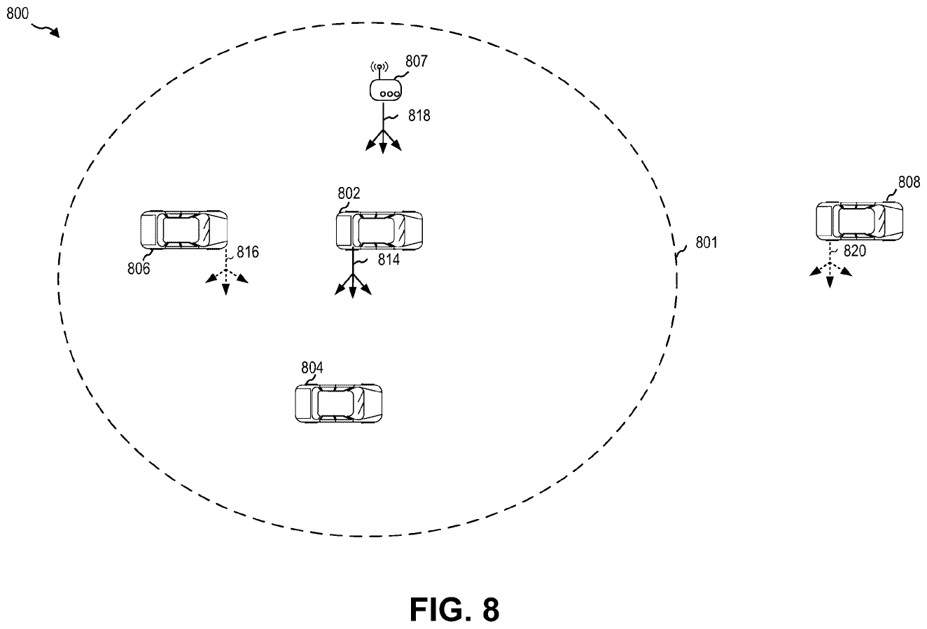

FIG. 8 illustrates an example 800 of wireless communication between devices based on sidelink communication, such as V2X or other D2D communication. The communication may be based on a slot structure. For example, transmitting UE 802 may transmit a transmission 814, e.g., comprising a control channel and/or a corresponding data channel, that may be received by receiving UEs 804, 806, 808. At least one UE may comprise an autonomous vehicle or an unmanned aerial vehicle. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The UEs 802, 804, 806, 808 may each be capable of operating as a transmitting device in addition to operating as a receiving device. Thus, UEs 806, 808 are illustrated as transmitting transmissions 816, 820. The transmissions 814, 816, 820 (and 818 by RSU 807) may be broadcast or multicast to nearby devices. For example, UE 808 may transmit communication intended for receipt by other UEs within a range 801 of UE 814. Additionally/alternatively, RSU 807 may receive communication from and/or transmit communication 818 to UEs 802, 804, 806, 808. UE 802, 804, 806, 808 or RSU 807 may comprise a detection component. UE 802, 804, 806, 808 or RSU 807 may also comprise a BSM or mitigation component.

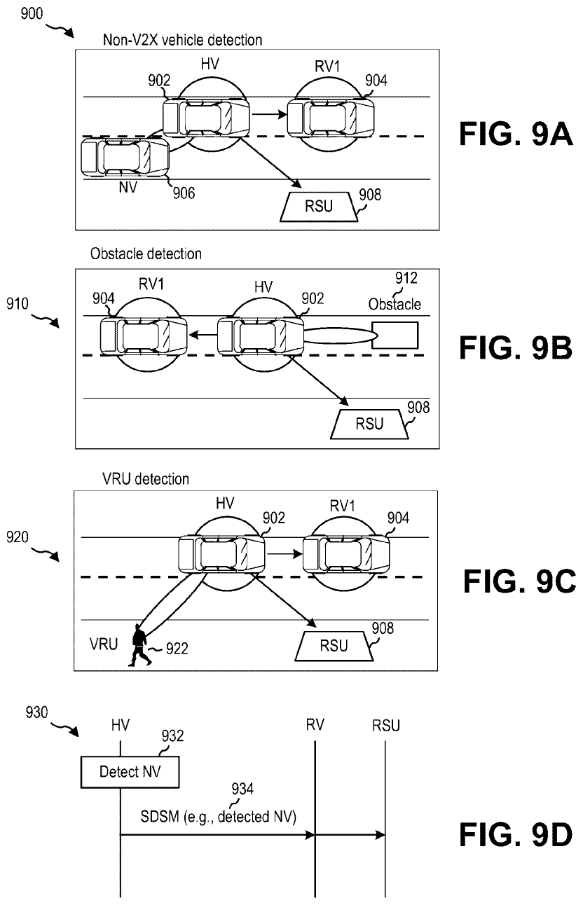

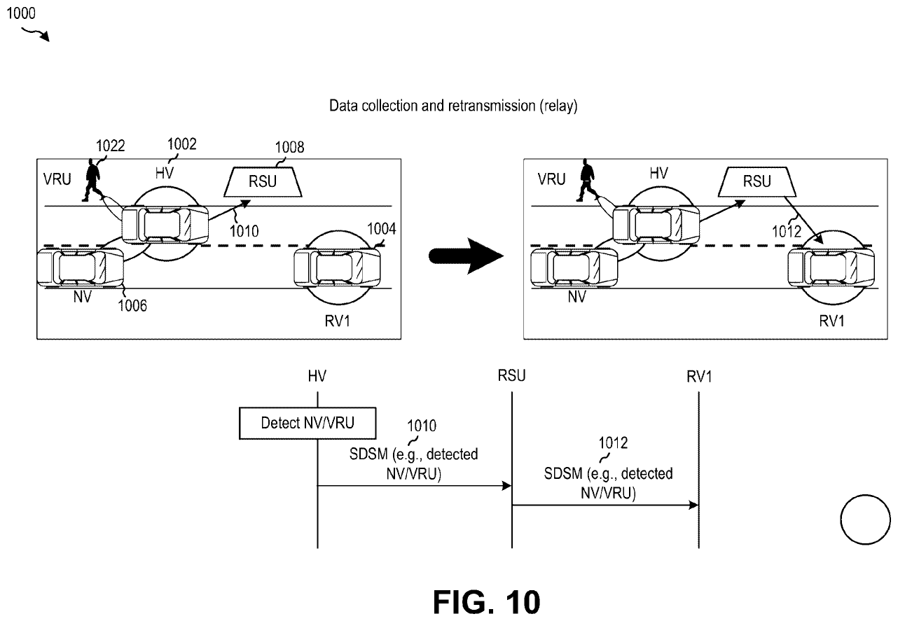

In wireless communications, such as V2X communications, V2X entities may perform sensor sharing with other V2X entities for cooperative and automated driving. For example, with reference to diagram 900 of FIG. 9A, the host vehicle (HV) 902 may detect a number of items within its environment. For example, the HV 902 may detect the presence of the non-V2X entity (NV) 906 at block 932. The HV 902 may inform other entities, such as a first remote vehicle (RV1) 904 or a roadside unit (RSU) 908, about the presence of the NV 906, if the RV1 904 and/or the RSU 908, by themselves, are unable to detect the NV 906. The HV 902 informing the RV1 904 and/or the RSU 908 about the NV 906 is a sharing of sensor information. With reference to diagram 910 of FIG. 9B, the HV 902 may detect a physical obstacle 912, such as a pothole, debris, or an object that may be an obstruction in the path of the HV 902 and/or RV1 904 that has not yet been detected by RV1 904 and/or RSU 908. The HV 902 may inform the RV1 and/or the RSU 908 of the obstacle 912, such that the obstacle 912 may be avoided. With reference to diagram 920 of FIG. 9C, the HV 902 may detect the presence of a vulnerable road user (VRU) 922 and may share the detection of the VRU 922 with the RV1 904 and the RSU 908, in instances where the RSU 908 and/or RV1 904 may not be able to detect the VRU 922. With reference to diagram 930 of FIG. 9D, the HV, upon detection of a nearby entity (e.g., NV, VRU, obstacle) may transmit a sensor data sharing message (SDSM) 934 to the RV and/or the RSU to share the detection of the entity. The SDSM 934 may be a broadcast message such that any receiving device within the vicinity of the HV may receive the message. In some instances, the shared information may be relayed to other entities, such as RVs. For example, with reference to diagram 1000 of FIG. 10, the HV 1002 may detect the presence of the NV 1006 and/or the VRU 1022. The HV 1002 may broadcast the SDSM 1010 to the RSU 1008 to report the detection of NV 1006 and/or VRU 1022. The RSU 1008 may relay the SDSM 1010 received from the HV 1002 to remote vehicles such that the remote vehicles are aware of the presence of the NV 1006 and/or VRU 1022. For example, the RSU 1008 may transmit an SDSM 1012 to the RV1 1004, where the SDSM 1012 includes information related to the detection of NV 1006 and/or VRU 1022.

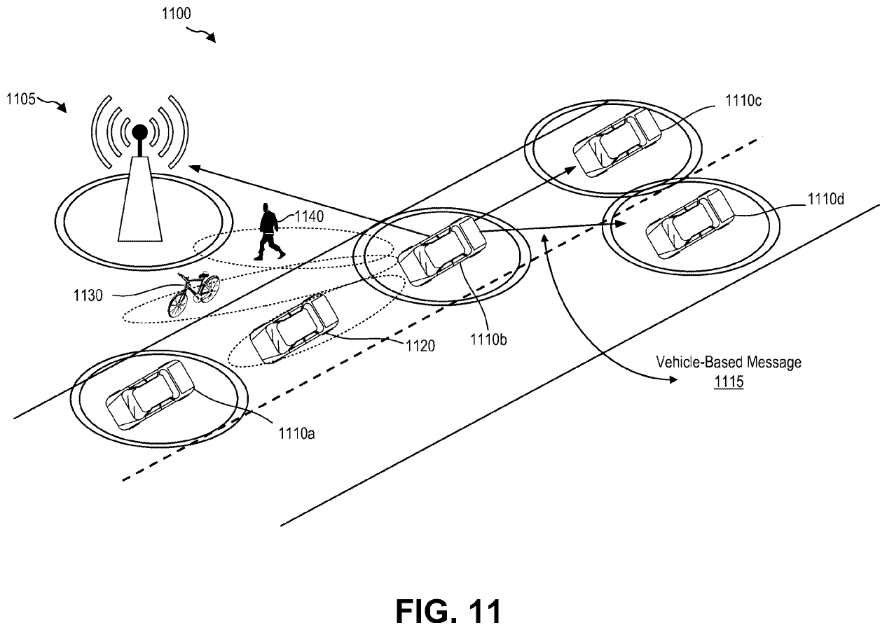

FIG. 11 is a diagram illustrating an example of a system 1100 for sensor sharing in wireless communications (e.g., V2X communications). In FIG. 11, the system 1100 is shown to include a plurality of equipped (e.g., V2X capable) network devices. The plurality of equipped network devices includes vehicles (e.g., automobiles) 1110a, 1110b, 1110c, 1110d, and an RSU 1105. Also shown are a plurality of non-equipped network devices, which include a non-equipped vehicle 1120, a VRU (e.g., a bicyclist) 1130, and a pedestrian 1140. The system 1100 may comprise more or less equipped network devices and/or more or less non-equipped network devices, than as shown in FIG. 11. In addition, the system 1100 may comprise more or less different types of equipped network devices (e.g., which may include equipped UEs) and/or more or less different types of non-equipped network devices (e.g., which may include non-equipped UEs) than as shown in FIG. 11. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In one or more examples, vehicles 1110a, 1110b, 1110c, 1110d and RSU 1105 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 1100. For example, vehicle 1110b may be a luxury vehicle and, as such, have more expensive, higher capability sensors than other vehicles that are economy vehicles. In one illustrative example, vehicle 1110b may have one or more higher capability LIDAR sensors (e.g., high capability optical lasers and optical sensors) than the other equipped network devices in the system 1100. In one illustrative example, a LIDAR of vehicle 1110b may be able to detect a VRU (e.g., cyclist) 1130 and/or a pedestrian 1140 with a large degree of confidence (e.g., a seventy percent degree of confidence). In another example, vehicle 1110b may have higher capability radar (e.g., high capability RF antennas) than the other equipped network devices in the system 1100. For instance, the radar of vehicle 1110b may be able to detect the VRU (e.g., cyclist) 1130 and/or pedestrian 1140 with a degree of confidence (e.g., an eight-five percent degree of confidence). In another example, vehicle 1110b may have higher capability camera (e.g., with higher resolution capabilities, higher frame rate capabilities, better lens, etc.) than the other equipped network devices in the system 1100.

During operation of the system 1100, the equipped network devices (e.g., RSU 1105 and/or at least one of the vehicles 1110a, 1110b, 1110c, 1110d) may transmit and/or receive sensing signals (e.g., RF and/or optical signals) to sense and detect vehicles (e.g., vehicles 1110a, 1110b, 1110c, 1110d, and 1120) and/or objects (e.g., VRU 1130 and pedestrian 1140) located within and surrounding the road. The equipped network devices (e.g., RSU 1105 and/or at least one of the vehicles 1110a, 1110b, 1110c, 1110d) may then use the sensing signals to determine characteristics (e.g., motion, dimensions, type, heading, and speed) of the detected vehicles and/or objects. The equipped network devices (e.g., RSU 1105 and/or at least one of the vehicles 1110a, 1110b, 1110c, 1110d) may generate at least one vehicle-based message 1115 (e.g., a V2X message, such as a Sensor Data Sharing Message (SDSM), a Basic Safety Message (BSM), a Cooperative Awareness Message (CAM), Collective Perception Messages (CPMs), and/or other type of message) including information related to the determined characteristics of the detected vehicles and/or objects.

The vehicle-based message 1115 may include information related to the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 1115 may also include information regarding the equipped network device's preference to receive vehicle-based messages from other certain equipped network devices. In some cases, the vehicle-based message 1115 may include the current capabilities of the equipped network device (e.g., vehicles 1110a, 1110b, 1110c, 1110d), such as the equipped network device's sensing capabilities (which can affect the equipped network device's accuracy in sensing vehicles and/or objects), processing capabilities, the equipped network device's thermal status (which can affect the vehicle's ability to process data), and the equipped network device's state of health.

In some aspects, the vehicle-based message 1115 may include a dynamic neighbor list (also referred to as a Local Dynamic Map (LDM) or a dynamic surrounding map) for each of the equipped network devices (e.g., vehicles 1110a, 1110b, 1110c, 1110d and RSU 1105). For example, each dynamic neighbor list can include a listing of all of the vehicles and/or objects that are located within a specific predetermined distance (or radius of distance) away from a corresponding equipped network device. In some cases, each dynamic neighbor list includes a mapping, which may include roads and terrain topology, of all of the vehicles and/or objects that are located within a specific predetermined distance (or radius of distance) away from a corresponding equipped network device.

In some implementations, the vehicle-based message 1115 may include a specific use case or safety warning, such as a do-not-pass warning (DNPW) or a forward collision warning (FCW), related to the current conditions of the equipped network device (e.g., vehicles 1110a, 1110b, 1110c, 1110d). In some examples, the vehicle-based message 1115 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

As noted previously, systems and techniques are described herein for transmitting and/or receiving groupcast messages using three-dimensional (3D) zone configuration information indicative of candidate receivers for respective groupcast messages. In one illustrative example, the systems and techniques can be used to provide 3D zone configuration information for V2X groupcast messages (e.g., including distance-based V2X groupcast messages). The 3D zone configuration information can be indicative of a reception zone corresponding to the candidate receivers of the respective groupcast message. The reception zone may be a two-dimensional (2D) area or may be a 3D area. The 3D zone configuration information can additionally be indicative of one or more of directional information and/or height information that can be used by candidate receiver UEs to determine the reception zone for a respective groupcast message.

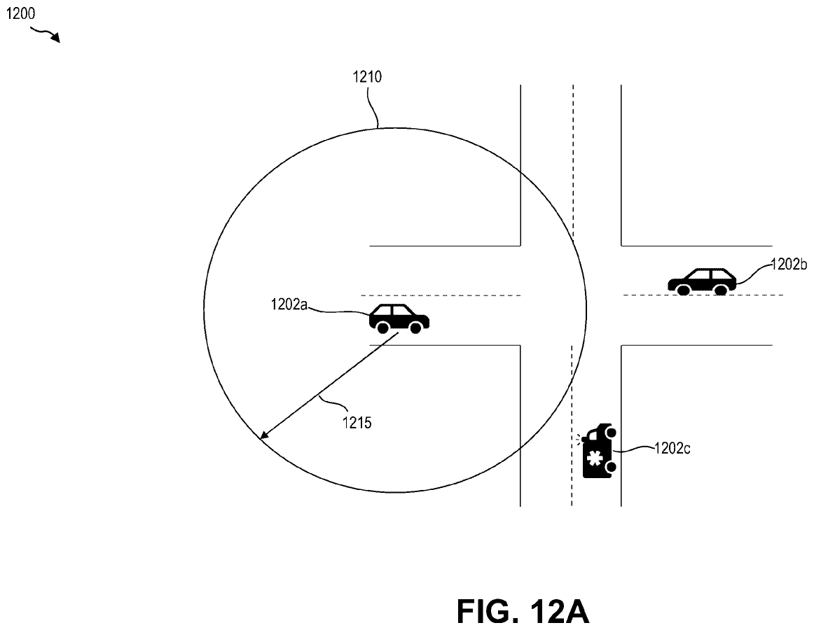

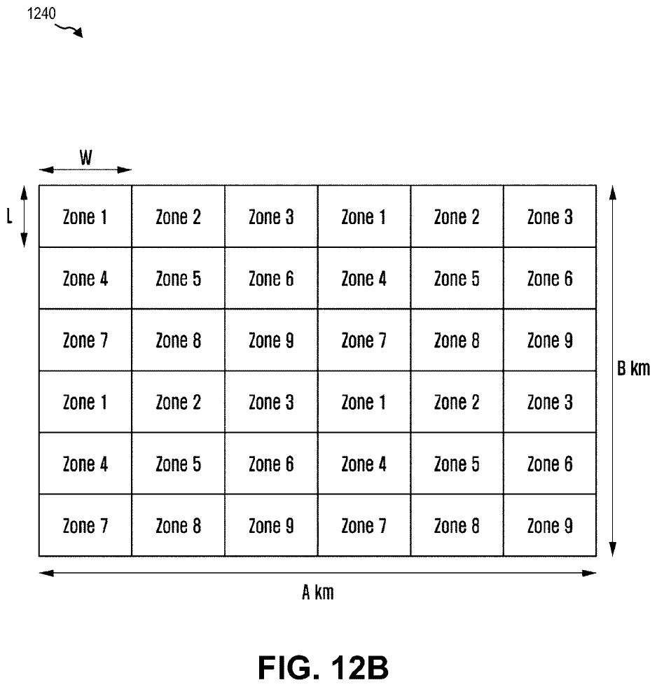

FIG. 12A is a diagram 1200 illustrating an example of two-dimensional (2D) distance-based groupcast in wireless communications (e.g., V2X communications), in accordance with some examples. A first vehicle UE 1202a can be configured as a transmitting UE (e.g., Tx UE) for one or more distance-based groupcast messages (e.g., one or more V2X groupcast messages). For example, a desired communication range of the distance-based groupcast message transmitted by the first vehicle UE 1202a can correspond to the area 1210, comprising a circular area with a radius 1215 centered at the current location of the vehicle UE 1202a.

The first vehicle UE 1202a can transmit (e.g., broadcast) sidelink information associated with and scheduling the distance-based groupcast message. The sidelink information can be indicative of the current location of the first vehicle UE 1202a and the desired communication range. For instance, if the first vehicle UE 1202a, a second vehicle UE 1202b, and/or a third vehicle UE 1202c are configured to implement distance-based groupcast messages using a default 2D circular area (e.g., such as the area 1210), UEs receiving the sidelink information from first vehicle UE 1202a can use the desired communication range and location information of the first vehicle UE 1202a to determine whether they are an intended receiver of the upcoming groupcast message that is scheduled by the sidelink information. For instance, the second vehicle UE 1202b and/or the third vehicle UE 1202c can determine a reception area for the groupcast message as a circular area centered on the location of the first vehicle UE 1202a and having a radius equal to the desired communication range 1215. If the second vehicle UE 1202b or the third vehicle UE 1202c determines that its current location is within the determined reception area 1210, the UE is an intended receiver of the groupcast message and may be required to correctly decode the packet(s) associated with the groupcast message.

In some aspects, the desired communication range 1215 can be determined based on a V2X application associated with the groupcast message. For instance, different types of V2X applications (e.g., and corresponding different types of V2X messages or communications) may utilize different range requirements for V2X distance-based groupcast messaging. In some examples, the range requirement for Cooperative Awareness Message (CAM) V2X packet delivery (e.g., CAM V2X groupcast messages) can be 300 meters. In another example, the range requirement for highway traffic jam warnings V2X packet delivery (e.g., highway traffic jam warning V2X groupcast messages) can be 1,000 meters; etc. In some examples, in distance-based packet delivery for V2X groupcast messages, only Rx UEs that are within a desired (e.g., minimum and/or required) communication range from the Tx UE are required to correctly decode the V2X groupcast message packet. For instance, in the example of FIG. 12, neither the second vehicle UE 1202b, nor the third vehicle UE 1202c, are within the range requirement given by the distance 1215 from first vehicle UE 1202a (e.g., neither vehicle UE 1202b nor vehicle UE 1202c are within the circular area 1210 with radius equal to the distance 1215), and are not required to correctly decode the V2X groupcast message from first vehicle UE 1202a.

In some implementations for NR V2X, a Tx UE location can be indicated by a zone identity (ID) for a current location of the Tx UE. The zone ID can be included in a plurality of zone IDs, each respective zone ID corresponding to a different geographical area (e.g., each zone ID can be an index to a particular zone/geographical area). The current location of the Tx UE can be within the particular geographical area corresponding to the zone ID signaled by the Tx UE to the potential or candidate Rx UEs.

FIG. 12B is a diagram illustrating an example of a plurality of zones 1240 that may be associated with V2X distance-based groupcast messaging. In some examples, a network entity (e.g., base station, gNB, etc.) may transmit zone configuration information to a UE in a cell, using an SL-ZoneConfig information element. The SL-ZoneConfig information element can include various parameters corresponding to the plurality of zones 1240. For instance, the SL-ZoneConfig information element can include an SL-Zone Width value indicating a width (W) of a zone, an SL-ZoneLength value indicating a length (L) of the zone, an SL-ZoneIdLongiMod indicating the number of zones configured based on longitude, and an SL-ZoneIdLatiMode indicating the number of zones configured based on latitude. In some examples, each of the SL-Zone Width and SL-ZoneLength parameters may be configured to 5m, 10m, 20m, 50m, 100m, 200m, or 500m; each of the SL-ZoneIdLongiMod and SL-ZoneIdLatiMode parameters may be configured to integer values between 1 and 4. For example, for an area of horizontal size A km and vertical size B km (e.g., as shown in FIG. 12B), the horizontal and vertical size of each zone of the plurality of zones 1240, and the number of zones included in the (A×B) km² area, can be configured using parameters in the SL-ZoneConfig information element.

In some examples, a UE can calculate zone ID information (e.g., Zone_id) corresponding to a current location of the UE, based on:

$${x}_{1} = Floor ( x / L ) Mod 64$$

$${y}_{1} = Floor ( y / L ) Mod 64$$

$$Zone\_id = {y}_{1} * 64 + {x}_{1}$$

Here, L is the value of SL-ZoneLength included in the SL-ZoneConfig information element. The value of x represents the geodesic distance in longitude between the UE's current location and the geographical coordinates (0, 0) (e.g., corresponding to the Greenwich Observatory), based on the WGS84 model and expressed in meters. The value of y represents the geodesic distance in latitude between the UE's current location and the geographical coordinates (0, 0), based on the WGS84 model and expressed in meters.

In some example implementations for NR V2X, distance-based hybrid automatic repeat request (HARQ) feedback can be utilized to enforce the communication range requirement. The Tx UE location can be indicated based on a zone identity (e.g., Zone_id, above) corresponding to the zone or area 1210 of FIG. 12A. The zone identity for the Tx UE location can be included in sidelink control information (SCI) transmitted by the Tx UE (e.g., the vehicle UE 1202a of FIG. 12A). The SCI transmitted by the Tx UE can additionally include or be indicative of the minimum communication range for a V2X groupcast message. In some examples, any Rx UEs that are within the minimum communication range indicated by the SCI may be required to transmit HARQ feedback to the Tx UE to ensure the distance-based packet delivery.

In some cases, V2X distance-based groupcast can be implemented using SCI format 2-B for the decoding of physical sidelink shared channel (PSSCH) transmissions (e.g., data transmissions of V2X groupcast messages). The SCI format 2-B information can be transmitted as a physical sidelink shared channel (PSSCH) transmission, and may be used to schedule a corresponding PSSCH transmission of V2X groupcast message. In some cases, V2X distance-based groupcast using SCI format 2-B utilizes a NACK-only HARQ feedback implementation. In the NACK-only HARQ feedback implementation, an Rx UE does not transmit an ACK in response to successfully receiving or decoding the SCI (e.g., no transmission in the success case), and transmits a NACK in response to unsuccessfully receiving or decoding the SCI (e.g., transmission only in the failure case).

In some examples, the SCI format 2-B information can include one or more of: a HARQ process number (e.g., on four bits); a new data indicator (e.g., on one bit); a redundancy version (e.g., on two bits); one or more source Layer-2 (L2) IDs (e.g., on eight bits); one or more destination L2 IDs (e.g., on 16 bits); a HARQ feedback enabled/disabled indicator (e.g., on one bit); a zone ID (e.g., on 12 bits); and a communication range requirement (e.g., on four bits, as determined by a higher layer parameter SL-ZoneConfig MCR-Index). In some cases, each UE can have one or more L2 IDs for V2X communication over PC5 (e.g., the one or more source L2 IDs and the one or more destination L2 IDs of the SCI format 2-B information).

In some implementations of V2X distance-based groupcast, the communication range requirement may be based on the x and y coordinates of the Tx UE, and corresponds to a 2D reception area that does not support a directional indication, a height indication, and/or a non-circular reception area indication for the one or more intended Rx UEs for receiving the V2X groupcast message.

The 2D circular communication range only indication used for current implementations of V2X distance-based groupcast can be sub-optimal for various V2X applications, scenarios, and/or message types. For instance, in the example of a two-way highway some vehicle UE data may be of interest (e.g., relevant) only to UEs moving in the same direction of travel, and there is a need for V2X groupcast messages that can indicate intended or candidate Rx UEs based on directionality. In the example of a multi-level highway some vehicle UE data may be of interest (e.g., relevant) only to UEs currently located on the same level (e.g., at the same height), and there is a need for V2X groupcast messages that can indicate the intended or candidate Rx UEs based on height. In the example of multiple highways merging and/or in the example of intersections, some vehicle UE data may be of interest (e.g., relevant) only to UEs within the same travel lane, and there is a need for V2X groupcast messages that can indicate the intended or candidate Rx UEs based on lane position. In the example of multi-story parking structures and/or multi-level highways, some vehicle UE data may be of interest (e.g., relevant) only to UEs within a particular level, and there is a need for V2X groupcast messages that can indicate the intended or candidate Rx UEs based on level(s) within the multi-level parking structure or highway. The systems and techniques described herein can be used to provide enhanced zone indication information that can be used to optimize distance-based groupcast transmission and reception. For instance, the enhanced zone indication information can be used by a Tx UE to target a V2X groupcast message to a narrower and more specific subset of nearby UEs, reducing the amount of unnecessary retransmissions in response to the Tx UE receiving a HARQ NACK indicative of failed decoding of the groupcast message at an Rx UE. Reducing unnecessary retransmissions to non-intended Rx UEs of a groupcast message can reduce network load and interference for V2X communications.

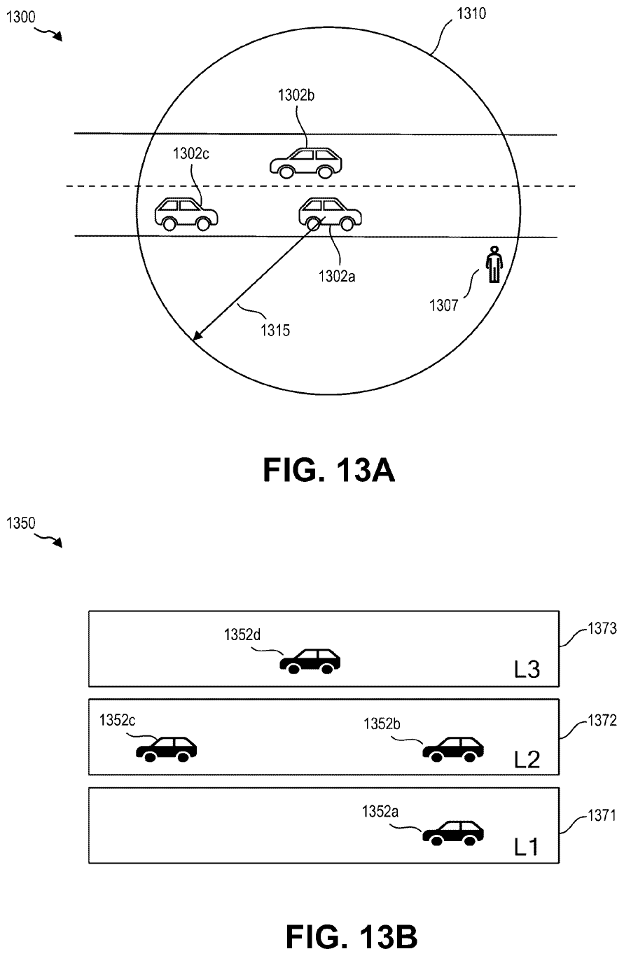

For example, FIG. 13A is a diagram illustrating an example of directional- and distance-based groupcast 1300 for V2X sidelink communications, and FIG. 13B is a diagram illustrating an example of height- and distance-based groupcast 1350 for V2X sidelink communications, in accordance with some examples. As used herein, directional- and distance-based groupcast (e.g., FIG. 13A) and height- and distance-based groupcast (e.g., FIG. 13B) may be collectively referred to as “enhanced groupcast” and/or “three-dimensional groupcast” (e.g., “3D groupcast”).

For instance, the example groupcast 1300 of FIG. 13A can utilize three-dimensional zone ID configurations and/or indications based on using two planar dimensions (x and y) and a third, directional dimension (e.g., θ; {N,E,S,W} cardinal directions; etc.). The example groupcast 1350 of FIG. 13B can utilize three-dimensional zone ID configurations and/or indications based on using two planar dimensions (x and y) and a third, height dimension (e.g., z). Three-dimensional zone ID configurations and/or indications can additionally be implemented based on combining the two planar dimensions (x and y) with various other third dimensions, such as an index to a particular lane of a multi-lane roadway, an index to a particular level of a multi-level parking structure or multi-level roadway, etc.

The three-dimensional zone configurations and/or indications utilized by the systems and techniques described herein can reduce network congestion and can improve resource efficiency within the network, as noted previously above. For instance, by using a three-dimensional zone configuration and indication rather than an existing 2D circular zone configuration and indication, the number of intended receivers (e.g., Rx UEs) of sensor sharing and/or collision warning, etc., V2X groupcast messages can be significantly reduced. Reducing the number of Rx UEs for V2X groupcast messages can allow a higher modulation coding scheme (MCS) to be used for the V2X groupcast messages (e.g., where the MCS defines the number of useful bits that can be transmitted per resource element (RE)) and/or can reduce the number of retransmissions performed by the Tx UE in response to receiving a HARQ NACK from an Rx UE.

In the example of FIG. 13A, a first vehicle UE 1302a can be a Tx UE for a V2X groupcast message. Based on the current location of the first vehicle UE 1302a (e.g., the zone ID corresponding to the current location of the first vehicle UE 1302a), a reception area 1310 can be defined in two dimensions (and can be referred to as a two-dimensional (2D) zone in some cases) for the intended receivers of the V2X groupcast message. For instance, the reception area 1310 can be a circular area with a radius given by the range requirement 1315 associated with the V2X groupcast message. In existing implementations using two-dimensional zone configurations and indications, both the second vehicle UE 1302b and the third vehicle UE 1302c would be required to correctly decode the V2X groupcast message from the first vehicle UE 1302a, based on the vehicle UEs 1302b and 1302c being within the minimum range given by the reception area 1310. A pedestrian UE (e.g., a UE carried by or otherwise associated with a pedestrian) may additionally be required to correctly decode the V2X groupcast message from the first vehicle UE 1302a in existing implementations using two-dimensional zone configurations and indications, based on the pedestrian UE being located within the minimum range of the reception area 1310.

In one illustrative example, the systems and techniques can implement enhanced V2X groupcast messaging based on using directional range information transmitted by the first vehicle UE 1302a to indicate an intended receive area for the groupcast message comprising a subset of the reception area 1310. For instance, the first vehicle UE 1302a may transmit a V2X groupcast message indicative of sensor sharing information with a vulnerable road user (VRU) 1307 entering an intersection ahead of the first vehicle UE 1302a. The sensor sharing information or messages with the VRU 1307 may be relevant to other vehicle UEs that are near the intersection and also moving towards the intersection. In some aspects, the first vehicle UE 1302a can transmit sidelink information (e.g., a PSCCH transmission scheduling a PSSCH transmission for the V2X groupcast message) indicating that the candidate receiver UEs of the VRU sensor sharing V2X groupcast message are only the vehicle UEs that are near the first vehicle UE 1302a and moving in the same direction as the first vehicle UE 1302a.

For example, the second vehicle UE 1302b is within the area of reception area 1310 (e.g., is within the minimum distance 1315 of first vehicle UE 1302a) but is not a candidate receiver UE, based on the second vehicle UE 1302b traveling in the opposite direction from the first vehicle UE 1302a. The third vehicle UE 1302c is within the area of reception area 1310 (e.g., is within the minimum distance 1315 of first vehicle UE 1302a) and is traveling in the same direction as the first vehicle UE 1302a, and is a candidate receiver UE for the VRU sensor sharing V2X groupcast message. The third vehicle UE 1302c may be required to correctly decode the VRU sensor sharing V2X groupcast message (e.g., required to send HARQ NACK feedback if the groupcast message is not successfully decoded). The second vehicle UE 1302b can ignore (e.g., skip decoding of) the VRU sensor sharing V2X groupcast message, based on being a non-candidate receiver UE for the V2X groupcast message.

In another example, the first vehicle UE 1302a can transmit a V2X groupcast message that includes a collision warning. A collision warning V2X groupcast message may be relevant only to other vehicle UEs that are located behind the first vehicle UE 1302a. The first vehicle UE 1302a can transmit sidelink information that includes directional range information for restricting the candidate Rx UEs (e.g., receivers of interest) for the collision warning V2X groupcast message to only a sub-area within the area of the reception area 1310. The third vehicle UE 1302c may be a candidate Rx UE that is required to correctly decode the collision warning V2X groupcast message from first vehicle UE 1302a. The second vehicle UE 1302b may be a non-candidate Rx UE that is not required to correctly decode the collision warning V2X groupcast message from first vehicle UE 1302a. For instance, the second vehicle UE 1302b can ignore (e.g., skip decoding of) the collision warning V2X groupcast message, based on being a non-candidate receiver UE for the V2X groupcast message.

In another illustrative example, enhanced V2X groupcast messaging can be implemented based on using height information transmitted by a Tx vehicle UE to indicate an intended receive area for a V2X groupcast message. For example, as noted previously, in a multi-story parking structure or multi-level highway, some vehicle UE data may be of interest only to other vehicle UEs on a particular level. For example, FIG. 13B illustrates a first vehicle UE 1352a located on a first level 1371 of a parking structure or highway, a second vehicle UE 1352b and a third vehicle UE 1352c located on a second level 1372 of the parking structure or highway, and a fourth vehicle UE 1352d located on a third level 1373 of the parking structure or highway. V2X groupcast messages from the first vehicle UE 1352a may be relevant only to other vehicle UEs also located on the first level 1371. The second, third, and fourth vehicle UEs 1352b, 1352c, 1352d (respectively) can receive sidelink information for a V2X groupcast message from the first vehicle UE 1352a with intended receivers indicated as any UEs also located on the first level 1371. The second, third, and fourth vehicle UEs 1352b-d can ignore the V2X groupcast message from first vehicle UE 1352, based on being located on different levels. In another example, a V2X groupcast message from second vehicle UE 1352b can indicate intended receivers are any UEs also located on the second level 1372. The third vehicle UE 1352c can be a required receiver that must successfully decode the V2X groupcast message from second vehicle UE 1352b or else transmit HARQ NACK feedback. The first vehicle UE 1352a and the fourth vehicle UE 1352d are not intended receivers of the V2X groupcast message from second vehicle UE 1352b, and can ignore the V2X groupcast message without decoding.

In one illustrative example, the systems and techniques can utilize an application layer configuration of different zone indication types for enhanced V2X groupcast messaging. For instance, the application layer of the V2X UEs can be used to configure a plurality of zone indication types, wherein each respective zone indication type of the plurality of zone indication types corresponds to one or more different V2X applications, services, message types, etc. Different zone indication types can utilize corresponding zone range information to indicate a receive area within a geographical zone corresponding to a zone ID of the Tx UE. For instance, a first directional zone indication type can be used to indicate a zone that includes only a certain direction based on the transmitter zone (e.g., includes a certain direction of the zone corresponding to the Tx UE zone ID). A second directional zone indication type can be used to indicate a zone that excludes a certain direction based on the transmitter zone (e.g., excludes a certain direction of the zone corresponding to the Tx UE zone ID).

In another example, a lane-based zone indication type can be used to indicate a zone comprising a particular lane section of a road. In some examples, a lane-based zone indication type can be used to indicate a zone comprising a particular lane or multiple lanes of a multi-lane highway. In another example, a height level zone indication type can be used to indicate a zone comprising one or more levels of a multi-level parking structure or multi-level highway. A height level zone indication type can be used to indicate a zone comprising respective portions of one or more levels of a multi-level parking structure or multi-level highway.

In some aspects, multiple zone indication modes (e.g., a plurality of zone indication modes) can be configured in the application layer of the V2X UEs, and may be used to configure the determination by Rx UEs of a particular zone indication type for a V2X groupcast message, where the particular zone indication type is included in the plurality of zone indication types. For example, the determined zone indication type for a V2X groupcast message can be determined based on one or more of a V2X application type, a V2X service type, a cast mode of the V2X transmission, etc.

In some examples, a default zone indication can be configured as a transmitter-centric (e.g., centered on the current location of the Tx UE) circular communication range, such as the circular communication range illustrated by the area 1210 centered on first vehicle UE 1202a and given by radius 1215 of FIG. 12, and/or the circular communication range of the reception area 1310 centered on first vehicle UE 1302a and given by radius 1315 of FIG. 13A, etc. In some cases, the default zone indication can be the transmitter centric circular communication range specified by 3GPP R16 C-V2X. In one illustrative example, a directional zone indication mode can be used to indicate a directional zone indication type using cardinal direction (e.g., N,E,S,W) directional indications. In some aspects, an angular zone indication mode can be used to indicate an angular zone indication type using quantized angle information and/or one or more ranges of angle values to indicate a limited selection of nearby UEs as the receiver candidates for a V2X groupcast message. In another illustrative example, a height indication, a story indication, and/or a level indication can be used in combination with the 2D zone indication (e.g., used in combination with the transmitter centric circular communication range zone indication). In some aspects, the systems and techniques can include and/or be used to implement a packet-specific zone indication mode. For example, a sensor sharing message packet transmission over V2X groupcast may include and/or correspond to objects in a particular direction, and the directional zone indication type may be most efficient for receiver UEs to detect and feedback HARQ NACK information (e.g., based on the receiver UE being within an identified receive area corresponding to the directional zone indication information, and based on the receiver UE unsuccessfully decoding the corresponding V2X groupcast message).

In one illustrative example, Tx vehicle UEs and/or Rx vehicle UEs can use their respective current location information, in combination with the application layer zone type configuration, to determine a particular zone ID for the current location of the vehicle UE. In some aspects, the current location of each vehicle UE can be a GPS-based location or other positioning system-based location. In some examples, the GPS or positioning system-based location of a vehicle UE can be fused with additional sensor data obtained by the vehicle UE (e.g., radar sensor data, lidar sensor data, camera sensor data, etc.) to determine the particular zone ID of a plurality of zone IDs of a particular zone indication type that corresponds to the current location of the vehicle UE.

For instance, a vehicle UE can fuse accelerometer and/or other inertial sensor data with GPS-based current location information of the vehicle UE, and can determine a direction of travel or movement of the vehicle UE. In some cases, a vehicle UE can use accelerometer and/or other inertial data to determine the part of the highway in which the vehicle UE is located. In another example, a vehicle UE can utilize camera data (e.g., images, video, video frames, etc.) to perform lane detection, street sign detection, etc., to determine a particular highway that the vehicle UE is traveling on (e.g., located on), to determine a particular lane that the vehicle UE is utilizing (e.g., located within), etc. In some aspects, a vehicle UE can utilize sign detection based on camera data to determine a particular parking level of a multi-level parking structure that the vehicle is located on, etc.

In some cases, a V2X groupcast message can be associated with a source L2 ID and a destination L2 ID. For instance, one or more source and destination L2 IDs can be included in the SCI format 2-B information (e.g., sidelink information) associated with and used to schedule the PSSCH transmission of the V2X groupcast message, as noted previously above. In existing implementations of distance-based V2C groupcast messaging, the source L2 ID may be determined based on information associated with the Tx UE alone (e.g., the source L2 ID in existing implementations may be a unique identifier of the Tx UE, and/or the destination L2 ID in existing implementations may be a unique identifier of one or more Rx UEs). In one illustrative example, the Tx vehicle UE can determine and configure source L2 ID information and/or destination L2 ID information of a V2X groupcast transmission based on the particular transmission zone that the Tx vehicle UE is located within (e.g., based on the determined zone ID for the current location of the UE, where the determined zone ID is included in a plurality of zone IDs corresponding to a particular zone indication type used and/or configured for the V2X groupcast transmission).

For example, the Tx UE can determine the source L2 ID for a V2X groupcast message based on the zone indication type to be used for the V2X groupcast transmission and based on corresponding zone mapping information from the application layer (e.g., mapping the current location of the Tx UE to a particular zone ID of a plurality of zone IDs of the zone indication type that is to be used for the V2X groupcast transmission). In another illustrative example, the Tx UE may additionally determine a receive zone (e.g., receive area) range for the V2X groupcast transmission, and can indicate the receive zone using one or more destination L2 IDs that are mapped to the determined receive zone. In some aspects, one or more destination L2 IDs can be used to indicate the receivers of interest for the V2X groupcast message (e.g., the candidate Rx vehicle UEs) based on directional and/or height information corresponding to the reception zone, based on the V2X application type, etc.

In some aspects, the Tx UE can transmit sidelink information indicative of the transmission zone (of a particular zone indication type) that the Tx UE is located within and/or indicative of one or more reception zones for intended Rx UEs of the V2X groupcast message. For instance, the Tx UE may directly indicate its transmission zone and/or one or more reception zones using one or more reserved bits within the SCI format 2-B sidelink information associated with and used to schedule the V2X message. In another example, a Tx UE may implicitly indicate its transmission zone and/or one or more reception zones by encoding the zone indication information in one or more source L2 IDs and/or destination L2 IDs.

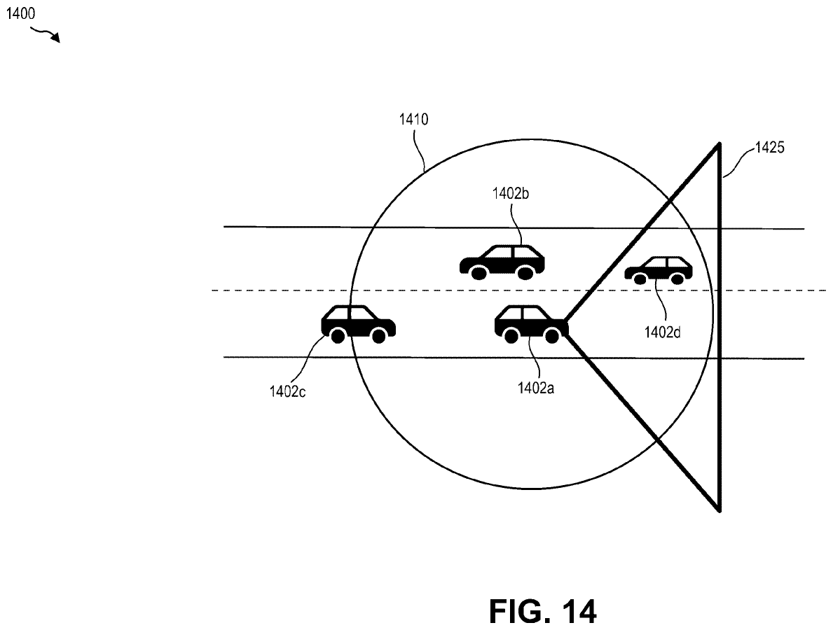

FIG. 14 is a diagram illustrating an example of enhanced V2X groupcast messaging 1400 based on a transmission zone indication (corresponding to transmission zone 1410) corresponding to a Tx UE and a reception zone (e.g., receive area) indication (corresponding to reception zone 1425) corresponding to intended receivers (e.g., candidate Rx UEs) of a V2X groupcast message. In one illustrative example, the Tx UE can indicate its Tx UE zone ID information in the SCI format 2-B sidelink information associated with and used to schedule the V2X groupcast message. Nearby UEs can receive the sidelink information and use at least the Tx UE zone ID information to determine whether it is an intended candidate receiver for the V2X groupcast message associated with the sidelink information. For instance, a nearby UE can decode the sidelink information and determine whether to receive the V2X groupcast message data packet(s) based on range information for the groupcast message, where the range information is indicative of a receive area within a geographical zone corresponding to the Tx UE zone ID.

In some aspects, for instance in examples where a V2X application type utilizes a directional zone indication type, a height-based or level-based zone indication type, and/or a 3D zone indication type, the Tx vehicle UE can transmit the sidelink information to be further indicative of a corresponding receive zone range. Based on the receive zone range, UEs that receive the sidelink information can decide whether to decode the scheduled V2X groupcast message data packet(s) and feedback a physical sidelink feedback channel (PSFCH) transmission indicative of a HARQ NACK if decoding is not successful.

In some examples, the receive zone can be indicated based on a mapping between respective receive zones and one or more destination L2 IDs (e.g., configured by the V2X application layer). In another example, the receive zone can be indicated as a receive zone ID carried by one or more reserved bits in the SCI format 2-B sidelink information. For instance, the receive zone ID can be indicated by a lower layer (e.g., the media access control (MAC) layer). In one illustrative example, the receive zone ID can be carried by a first set of one or more reserved bits in the SCI format 2-B sidelink information and the transmit zone ID can be carried by a second set of one or more reserved bits in the SCI format 2-B sidelink information. In some examples, a Tx UE can indicate a three-dimensional zone indication based on sidelink information including the transmit zone ID and not including a receive zone ID. In some examples, a Tx UE can indicate a three-dimensional zone indication based on sidelink information including a receive zone ID and not including a transmit zone ID. In some examples, a Tx UE can indicate a three-dimensional zone indication based on sidelink information including both a transmit zone ID and a receive zone ID. In another illustrative example, the Tx UE can indicate a three-dimensional zone indication based on selecting a particular transmission zone and a particular reception zone for the V2X groupcast message, where the particular Tx zone and the particular Rx zone are both selected from the same plurality of zones (e.g., from the same plurality of zone IDs).

In the example of FIG. 14, a first vehicle UE 1402a can be a Tx UE of a V2X groupcast message. The first vehicle UE 1402a can transmit sidelink information indicative of a transmission zone and/or a reception zone for identifying candidate receivers of the V2X groupcast message.

For instance, in examples where the sidelink information is indicative of only a transmission zone, the transmission zone can be configured to be the same as the receive area for the V2X groupcast message. In one illustrative example, a Tx zone-only sidelink information transmitted by the first vehicle UE 1402a can include a Tx zone ID corresponding to the reception zone 1425. For instance, the vehicle UE 1402d can decode the V2X groupcast message from the first vehicle UE 1402a based on being located within the reception zone 1425.

In another illustrative example, in examples where the sidelink information is indicative of only a reception zone, the reception zone can be configured to be the same as the receive area for the V2X groupcast message. For instance, an Rx zone-only sidelink information transmitted by the first vehicle UE 1402a can include an Rx zone ID corresponding to the reception zone 1425. For instance, the vehicle UE 1402d can decode the V2X groupcast message from the first vehicle UE 1402a based on being located within the reception zone 1425.

In another illustrative example, the sidelink information can be indicative of a Tx zone ID corresponding to a transmission zone 1410 of the first vehicle UE 1402a and an Rx zone ID corresponding to a reception zone 1425 for candidate receivers of the V2X groupcast message. Nearby UEs (e.g., UEs within range to receive and decode the sidelink information transmitted by the first vehicle UE 1402a) can determine the receive area for the V2X groupcast message from the first vehicle UE 1402a as the intersection between the transmission zone 1410 and the reception zone 1425. For instance, the vehicle UEs 1402b, 1402c, and 1402d are each located within the transmission zone 1410. Only vehicle UE 1402d is also located within the reception zone 1425. Based on being located within the receive area comprising the intersection between transmission zone 1410 and reception zone 1425, the vehicle UE 1402d can determine it is a required receiver of the V2X groupcast message from the first vehicle UE 1402a, and must successfully decode the V2X groupcast message from the first vehicle UE 1402a or otherwise transmit HARQ NACK feedback indicative of unsuccessful decoding.

In one illustrative example, an Rx UE (e.g., vehicle UE, V2X-capable UE, etc.) can be any UE that is within range of a Tx UE, where the Rx UE receives and decodes sidelink information corresponding to a V2X groupcast message of the Tx UE. In some aspects, a UE application layer of each Rx UE can be used to determine whether the Rx UE is a receiver candidate (e.g., intended or required receiver) of the V2X groupcast message corresponding to the sidelink information. For instance, the Rx UE can determine whether it is a receiver candidate for the V2X groupcast message based on a receive zone indication included in the sidelink information from the Tx UE and a respective zone determination for the Rx UE itself. For instance, the respective zone determination for the Rx UE may be a receive zone ID that is intersected with a transmission zone ID to determine the receive zone (e.g., receive area for the V2X groupcast message) or may be a zone ID directly indicative of the receive zone (e.g., receive area) for the V2X groupcast message. In some examples, the respective zone determination for the Rx UE can include comparing a current location of the Rx UE to the identified receive zone from the sidelink information. In some examples, the respective zone determination for the Rx UE can include using a current location of the Rx UE to identify an Rx UE zone and compare the Rx UE zone to the identified receive zone from the sidelink information.

In some examples, where the sidelink information includes range information indicative of a receive area that is not a transmitter centric circular 2D area (e.g., includes directional, height, level, story, lane, etc., range information), the receiving range for the V2X groupcast message from the Tx UE is not dependent on the Minimum Communication Range (MCR) value only (e.g., where the MCR is the value of the radius of the transmitter centric circular 2D area used in existing implementations (e.g., radius 1215 of FIG. 12A, radius 1315 of FIG. 13A, etc., may be MCR values)). In some aspects, where the sidelink information indicates that an Rx UE is not a receiver candidate for a V2X groupcast message (e.g., based on the range indication or range information of the sidelink information from the Tx UE, for instance corresponding to a range of destination L2 ID values), the Rx UE does not decode the PSSCH transmission of the V2X groupcast message and sends neither HARQ ACK nor HARQ NACK feedback. If the sidelink information indicates that an Rx UE is a receiver candidate for a V2X groupcast message, the Rx UE may be required to successfully decode the PSSCH transmission of the V2X groupcast message, sending only HARQ NACK feedback if decoding is not successfully. In some aspects, PSFCH V2X transmissions can be reduced, and can be associated with a corresponding reduction in PSSCH retransmissions of the V2X groupcast message by the Tx UE in response to receiving a HARQ NACK to the initial PSSCH transmission of the V2X groupcast message.

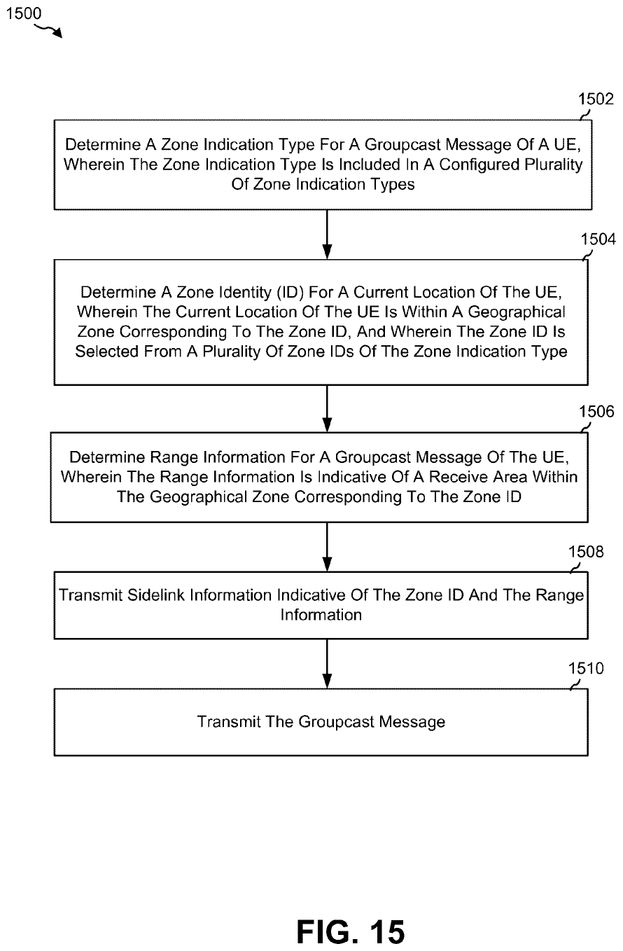

FIG. 15 is a flow chart illustrating an example of a process 1500 for wireless communications. The process 1500 can be performed by a User Equipment (UE) or by a component, system, or apparatus of the UE (e.g., a chipset of the UE, or other component or system of the UE). For example, the UE can include one or more of the UEs illustrated in FIG. 1 (e.g., including UE 104, UE 152, UE 164, UE 182, UE 190, etc.); the UE 204 of FIG. 2A or FIG. 2B; the UE 221c of FIG. 2C; the UEs 304, 305, 307 of FIG. 3; the vehicle 404 of FIG. 4; the UE 507 of FIG. 5; the UEs 602, 604 of FIG. 6; the UEs 702, 704, 706 of FIG. 7A or FIG. 7B; the UEs 802, 804, 806, 808 of FIG. 8; the UEs 902, 904 of FIGS. 9A-9D; the UEs 1004, 1006 of FIG. 10; the UEs 1110a, 1110b, 1110c, 1110d, 1120 of FIG. 11; the UEs 1202a, 1202b, 1202c of FIG. 12; the UEs 1302a, 1302b, 1302c of FIG. 13A and/or a user UE associated with user 1307 of FIG. 13A; the UEs 1352a, 1352b, 1352c of FIG. 13B; the UEs 1402a, 1402b, 1402c, 1402d of FIG. 14; etc.

In one illustrative example, the process 1500 can be performed by a source UE, such as a source V2X UE configured to transmit one or more V2X groupcast messages. For instance, the process 1500 can be performed by a UE that is the same as or similar to one or more of the connected vehicles (e.g., vehicle UE, V2X UE, etc.) described herein with respect to one or more of FIGS. 3-14 and which can be referred to herein as “a source UE” (e.g., a source or originator of one or more V2X UL transmissions, such as V2X groupcast messages).

At block 1502, the UE (or component, system, or apparatus thereof) can determine a zone indication type for a groupcast message of the UE. The zone indication type is included in a configured plurality of zone indication types.

At block 1504, the UE (or component, system, or apparatus thereof) can determine a zone identity (ID) for a current location of the UE. The current location of the UE is within a geographical zone corresponding to the zone ID. The zone ID is selected from a plurality of zone IDs of the zone indication type. In some aspects, the geographical zone includes a transmission zone for the groupcast message of the UE, and the zone ID includes a transmission zone ID corresponding to the transmission zone.

At block 1506, the UE (or component, system, or apparatus thereof) can determine range information for the groupcast message. The range information is indicative of a receive area within the geographical zone corresponding to the zone ID. In some aspects, to determine the range information for the groupcast message, the UE (or component, system, or apparatus thereof) can determine a receive zone ID corresponding to a receive zone for the groupcast message. In some cases, the receive area includes an intersection between the receive zone and the transmission zone for the groupcast message. In some examples, the UE (or component, system, or apparatus thereof) can determine the receive zone from a plurality of configured receive zones and can determine the transmission zone from a plurality of configured transmission zones. In some cases, the plurality of configured receive zones and the plurality of configured transmission zones are the same. In some aspects, the sidelink information includes one or more Layer-2 (L2) IDs indicative of the receive zone ID. In some examples, the sidelink information includes one or more Sidelink Control Information (SCI) reserved bits indicative of the receive zone ID. In some cases, the sidelink information further includes one or more SCI reserved bits indicative of the transmission zone ID.

At block 1508, the UE (or component, system, or apparatus thereof) can transmit sidelink information indicative of the zone ID and the range information. In some cases, the sidelink information is configured to cause one or more candidate UEs located in the receive area to decode the groupcast message.

At block 1510, the UE (or component, system, or apparatus thereof) can transmit the groupcast message.

In some aspects, the UE (or component, system, or apparatus thereof) can receive a hybrid automatic repeat request (HARQ) negative acknowledgement (NACK) corresponding to the groupcast message. The HARQ NACK is indicative of unsuccessful decoding of the groupcast message by a candidate UE located in the receive area.

In some cases, the sidelink information includes a source L2 ID indicative of one or more of the zone indication type associated with the groupcast message or the zone ID. In such cases, the sidelink information can also include a destination L2 ID indicative of the range information. In some aspects, the source L2 ID is further indicative of one or more of directional information of the geographical zone or height information of the geographical zone. In some examples, the sidelink information includes a first destination L2 ID indicative of directional or angular information corresponding to a first receive area within the geographical zone. In such examples, the sidelink information also includes a second destination L2 ID indicative of directional or angular information corresponding to a second receive area within the geographical zone, where the first receive area is different from the second receive area. In some cases, the sidelink information includes: a first destination L2 ID indicative of a first range of height values corresponding to a first receive area within the geographical zone. In such cases, the sidelink information can also include a second destination L2 ID indicative of a second range of height values corresponding to a second receive area within the geographical zone, where the first receive area is different from the second receive area.

In some aspects, the sidelink information includes Sidelink Control Information (SCI) information included in a physical sidelink control channel (PSCCH) transmission. In some cases, the groupcast message includes a vehicle-to-everything (V2X) message included in a physical sidelink shared channel (PSSCH) transmission.

In some cases, the UE is a vehicle-to-everything (V2X) UE (e.g., a vehicle or other V2X UE) and the groupcast message is a V2X groupcast message between the V2X UE and one or more receive candidate UEs located within the receive area. In such cases, the range information can be indicative of a cardinal direction and/or an angular range relative to a current direction of movement of the V2X UE. In some examples, the receive area is located ahead of a current direction of movement of the V2X UE or behind the current direction of movement of the V2X UE.

In some cases, the geographical zone is included in a plurality of geographical zones associated with the zone indication type. In such cases, a shape and/or geometric dimensions of each respective geographical zone of the plurality of geographical zones can be the same, based on the zone indication type. In such cases, each respective geographical zone may correspond to a lane of a roadway, a portion of a lane of a roadway, and/or a direction of travel within a lane of a roadway. In some aspects, each respective geographical zone may corresponds to a different level of a multi-level parking structure or a different level of a multi-level roadway.

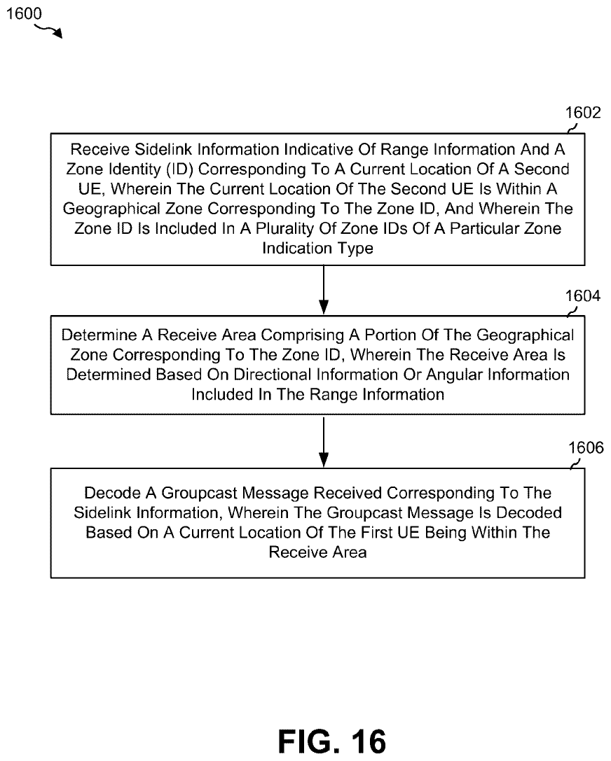

FIG. 16 is a flow chart illustrating another example of a process 1600 for wireless communications. The process 1600 can be performed by a User Equipment (UE) or by a component, system, or apparatus of the UE (e.g., a chipset of the UE, or other component or system of the UE). For example, the UE can include one or more of the UEs illustrated in FIG. 1 (e.g., including UE 104, UE 152, UE 164, UE 182, UE 190, etc.); the UE 204 of FIG. 2A or FIG. 2B; the UE 221c of FIG. 2C; the UEs 304, 305, 307 of FIG. 3; the UE 404 of FIG. 4; the UE 507 of FIG. 5; the UEs 602, 604 of FIG. 6; the UEs 702, 704, 706 of FIG. 7A or FIG. 7B; the UEs 802, 804, 806, 808 of FIG. 8; the UEs 902, 904 of FIGS. 9A-9D; the UEs 1004, 1006 of FIG. 10; the UEs 1110a, 1110b, 1110c, 1110d, 1120 of FIG. 11; the UEs 1202a, 1202b, 1202c of FIG. 12; the UEs 1302a, 1302b, 1302c of FIG. 13A and/or a user UE associated with user 1307 of FIG. 13A; the UEs 1352a, 1352b, 1352c of FIG. 13B; the UEs 1402a, 1402b, 1402c, 1402d of FIG. 14; etc.

In some cases, the process 1600 can be performed by a UE that is different than a UE used to perform process 1500. For instance, the process 1600 can be performed by a V2X destination UE (e.g., a V2X-capable UE) associated with a V2X source UE that performs process 1500. The “destination UE” can refer to a V2X-enabled or V2X-capable UE that is associated with the source UE. For instance, a destination UE may be subscribed to the source UE to receive (e.g., from the network), one or more of the V2X groupcast messages originated by the source UE. In some examples, a destination UE may transmit a request to the network indicative of a request to subscribe to some (or all) of the V2X groupcast messages originated by the source UE. In other examples, the network may identify one or more destination UEs for receiving a V2X groupcast message originated by the source UE. In some examples, the source UE may provide the network with information indicative of one or more destination UEs for receiving in DL a V2X groupcast message originated by the source UE.

At block 1602, the UE (or component, system, or apparatus thereof) can receive sidelink information indicative of range information and a zone identity (ID) corresponding to a current location of a second UE. The current location of the second UE is within a geographical zone corresponding to the zone ID. The zone ID is included in a plurality of zone IDs of a particular zone indication type determine a receive area including a portion of the geographical zone corresponding to the zone ID. The receive area is determined based on directional information or angular information included in the range information. In some cases, the sidelink information is configured to cause one or more candidate UEs located in the receive area to decode the groupcast message, where the first UE is included in the one or more candidate UEs.

In some aspects, the geographical zone includes a transmission zone for the groupcast message of the UE, and the zone ID includes a transmission zone ID corresponding to the transmission zone. In some cases, the range information is based on a receive zone ID corresponding to a receive zone for the groupcast message. In some examples, the receive area includes an intersection between the receive zone and the transmission zone for the groupcast message. In some cases, the receive zone is included in a plurality of configured receive zones and the transmission zone is included in a plurality of configured transmission zones. In some examples, the plurality of configured receive zones and the plurality of configured transmission zones are the same.

In some aspects, the sidelink information includes one or more Layer-2 (L2) IDs indicative of the receive zone ID. In some cases, the sidelink information includes one or more Sidelink Control Information (SCI) reserved bits indicative of the receive zone ID. In some examples, the sidelink information further includes one or more SCI reserved bits indicative of the transmission zone ID.

At block 1604, the UE (or component, system, or apparatus thereof) can decode a groupcast message received corresponding to the sidelink information. The groupcast message is decoded based on a current location of the first UE being within the receive area.

In some aspects, the UE (or component, system, or apparatus thereof) can transmit a hybrid automatic repeat request (HARQ) negative acknowledgement (NACK) corresponding to the groupcast message. The HARQ NACK is indicative of unsuccessful decoding of the groupcast message by the first UE.

In some cases, the sidelink information includes a source L2 ID indicative of one or more of the zone indication type associated with the groupcast message or the zone ID. In such cases, the sidelink information can also include a destination L2 ID indicative of the range information. In some instances, the source L2 ID is further indicative of one or more of directional information of the geographical zone or height information of the geographical zone. In some examples, the sidelink information includes a first destination L2 ID indicative of directional or angular information corresponding to a first receive area within the geographical zone. In such examples, the sidelink information may also include a second destination L2 ID indicative of directional or angular information corresponding to a second receive area within the geographical zone, where the first receive area is different from the second receive area. In some aspects, the sidelink information includes a first destination L2 ID indicative of a first range of height values corresponding to a first receive area within the geographical zone. In such aspects, the sidelink information may also include a second destination L2 ID indicative of a second range of height values corresponding to a second receive area within the geographical zone, where the first receive area different from the second receive area.

In some aspects, the sidelink information includes Sidelink Control Information (SCI) information included in a physical sidelink control channel (PSCCH) transmission. In such aspects, the groupcast message may include a vehicle-to-everything (V2X) message included in a physical sidelink shared channel (PSSCH) transmission.

In some cases, the first UE is a V2X-capable UE (e.g., a V2X-capable vehicle or other V2X-capable UE) and the second UE is a V2X UE. In such cases, the groupcast message may be a V2X groupcast message between the V2X UE and the V2X-capable UE. In some examples, the range information is indicative of a cardinal direction and/or an angular range relative to a current direction of movement of the V2X UE. In some cases, the receive area is located ahead of a current direction of movement of the V2X UE or behind the current direction of movement of the V2X UE.

In some aspects, the geographical zone is included in a plurality of geographical zones associated with the zone indication type. In such aspects, a shape and/or geometric dimensions of each respective geographical zone of the plurality of geographical zones may be the same, based on the zone indication type. In some instances, each respective geographical zone corresponds to a lane of a roadway, a portion of a lane of a roadway, and/or a direction of travel within a lane of a roadway. In some cases, each respective geographical zone corresponds to a different level of a multi-level parking structure or a different level of a multi-level roadway.

The wireless communication device (e.g., UE) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 1500 of FIG. 15, the process 1600 of FIG. 16, and/or other processed described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1500 of FIG. 15, the process 1600 of FIG. 16, and/or other processed described herein may be illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1500 of FIG. 15, the process 1600 of FIG. 16, and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

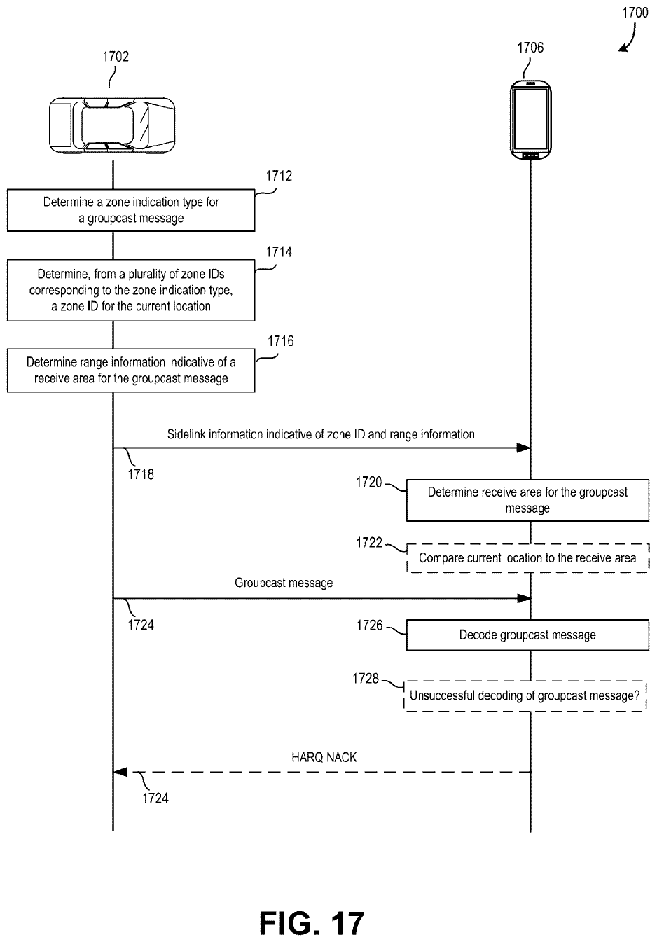

FIG. 17 is a signaling diagram corresponding to a process for wireless communication 1700 that can be performed between a first UE 1702 and a second UE 1706. In some cases, the first UE 1702 can be the same as or similar to a UE associated with performing process 1500 of FIG. 15. For instance, the first UE 1702 can be a V2X UE. In some cases, the second UE 1706 can be the same as or similar to a UE associated with performing process 1600 of FIG. 16. For instance, the second UE 1706 can be a V2X UE, a V2X-capable UE, a pedestrian UE, etc.

In some examples, at block 1712, the first UE 1702 can determine a zone indication type for a groupcast message. For instance, the groupcast message can be a V2X groupcast message that is transmitted using sidelink communications between the first UE 1702 and one or more additional entities (e.g., such as second UE 1706). In some cases, the V2X groupcast message can be a distance-based V2X groupcast message. In some aspects, the V2X groupcast message can be a physical sidelink shared channel (PSSCH) transmission of the first UE 1702. The V2X groupcast message can be associated with corresponding sidelink information indicative of the intended or candidate receivers of the V2X groupcast message. The corresponding sidelink information can additionally schedule the V2X groupcast message (e.g., can schedule the PSSCH transmission corresponding to the V2X groupcast message). For instance, the corresponding sidelink information can be included as sidelink control information (SCI) of a physical sidelink control channel (PSCCH) transmission of the first UE 1702.

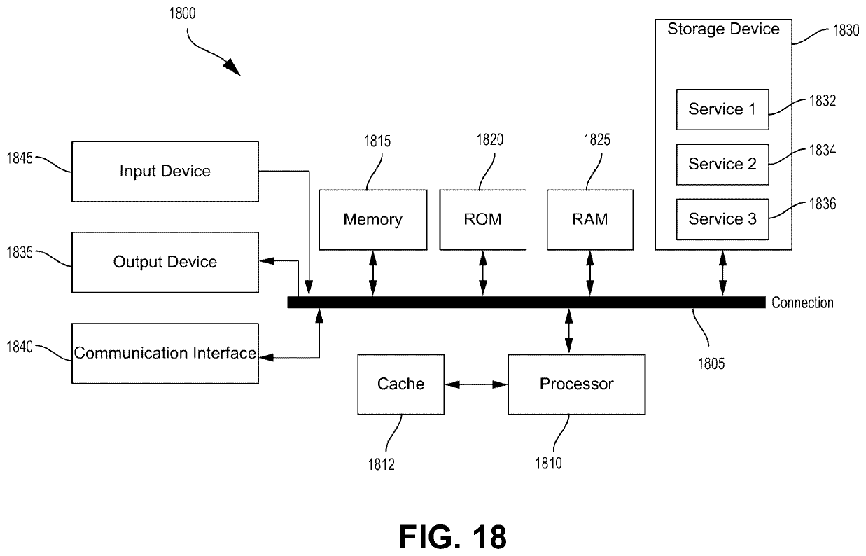

FIG. 18 is a block diagram illustrating an example of a computing system 1800, which may be employed by the disclosed systems and techniques for enhanced zone configuration indication for V2X groupcast messages. In particular, FIG. 18 illustrates an example of computing system 1800, which can be for example any computing device making up internal computing system, a remote computing system, a camera, or any component thereof in which the components of the system are in communication with each other using connection 1805. Connection 1805 can be a physical connection using a bus, or a direct connection into processor 1810, such as in a chipset architecture. Connection 1805 can also be a virtual connection, networked connection, or logical connection.

In some aspects, computing system 1800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1800 includes at least one processing unit (CPU or processor) 1810 and connection 1805 that communicatively couples various system components including system memory 1815, such as read-only memory (ROM) 1820 and random access memory (RAM) 1825 to processor 1810. Computing system 1800 can include a cache 1812 of high-speed memory connected directly with, in close proximity to, or integrated as part of processor 1810.

Processor 1810 can include any general purpose processor and a hardware service or software service, such as services 1832, 1834, and 1836 stored in storage device 1830, configured to control processor 1810 as well as a special-purpose processor where software instructions are incorporated into the actual processor design. Processor 1810 may essentially be a completely self-contained computing system, containing multiple cores or processors, a bus, memory controller, cache, etc. A multi-core processor may be symmetric or asymmetric.

To enable user interaction, computing system 1800 includes an input device 1845, which can represent any number of input mechanisms, such as a microphone for speech, a touch-sensitive screen for gesture or graphical input, keyboard, mouse, motion input, speech, etc. Computing system 1800 can also include output device 1835, which can be one or more of a number of output mechanisms. In some instances, multimodal systems can enable a user to provide multiple types of input/output to communicate with computing system 1800.

Computing system 1800 can include communications interface 1840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID)) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1840 may also include one or more range sensors (e.g., LIDAR sensors, laser range finders, RF radars, ultrasonic sensors, and infrared (IR) sensors) configured to collect data and provide measurements to processor 1810, whereby processor 1810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1840 may also include one or more Global Navigation Satellite System (GNSS) receivers or transceivers that are used to determine a location of the computing system 1800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1830 can include software services, servers, services, etc., that when the code that defines such software is executed by the processor 1810, it causes the system to perform a function. In some aspects, a hardware service that performs a particular function can include the software component stored in a computer-readable medium in connection with the necessary hardware components, such as processor 1810, connection 1805, output device 1835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus of a user equipment (UE) for wireless communications, comprising: at least one memory; and at least one processor coupled to the at least one memory, wherein the at least one processor is configured to: determine a zone indication type for a groupcast message of the UE, wherein the zone indication type is included in a configured plurality of zone indication types; determine a zone identity (ID) for a current location of the UE, wherein the current location of the UE is within a geographical zone corresponding to the zone ID, and wherein the zone ID is selected from a plurality of zone IDs of the zone indication type; determine range information for the groupcast message, wherein the range information is indicative of a receive area within the geographical zone corresponding to the zone ID; transmit sidelink information indicative of the zone ID and the range information; and transmit the groupcast message.

Aspect 2. The apparatus of Aspect 1, wherein the sidelink information is configured to cause one or more candidate UEs located in the receive area to decode the groupcast message.

Aspect 3. The apparatus of any one of Aspects 1 or 2, wherein the at least one processor is further configured to: receive a hybrid automatic repeat request (HARQ) negative acknowledgement (NACK) corresponding to the groupcast message, wherein the HARQ NACK is indicative of unsuccessful decoding of the groupcast message by a candidate UE located in the receive area.

Aspect 4. The apparatus of any one of Aspects 1 to 3, wherein the sidelink information includes: a source Layer-2 (L2) ID indicative of one or more of the zone indication type associated with the groupcast message or the zone ID; and a destination L2 ID indicative of the range information.

Aspect 5. The apparatus of Aspect 4, wherein the sidelink information includes: a first destination L2 ID indicative of directional or angular information corresponding to a first receive area within the geographical zone; and a second destination L2 ID indicative of directional or angular information corresponding to a second receive area within the geographical zone, the first receive area different from the second receive area.

Aspect 6. The apparatus of Aspect 4, wherein the sidelink information includes: a first destination L2 ID indicative of a first range of height values corresponding to a first receive area within the geographical zone; and a second destination L2 ID indicative of a second range of height values corresponding to a second receive area within the geographical zone, the first receive area different from the second receive area.

Aspect 7. The apparatus of any one of Aspects 4 to 6, wherein the source L2 ID is further indicative of one or more of directional information of the geographical zone or height information of the geographical zone.

Aspect 8. The apparatus of any one of Aspects 1 to 7, wherein the geographical zone comprises a transmission zone for the groupcast message of the UE, and wherein the zone ID comprises a transmission zone ID corresponding to the transmission zone.

Aspect 9. The apparatus of Aspect 8, wherein, to determine the range information for the groupcast message, the at least one processor is configured to: determine a receive zone ID corresponding to a receive zone for the groupcast message.

Aspect 10. The apparatus of Aspect 9, wherein the receive area comprises an intersection between the receive zone and the transmission zone for the groupcast message.

Aspect 11. The apparatus of any one of Aspects 9 or 10, wherein the at least one processor is configured to: determine the receive zone from a plurality of configured receive zones; and determine the transmission zone from a plurality of configured transmission zones.

Aspect 12. The apparatus of Aspect 11, wherein the plurality of configured receive zones and the plurality of configured transmission zones are the same.

Aspect 13. The apparatus of any one of Aspects 9 to 12, wherein the sidelink information includes one or more Layer-2 (L2) IDs indicative of the receive zone ID.

Aspect 14. The apparatus of any one of Aspects 9 to 12, wherein the sidelink information includes one or more Sidelink Control Information (SCI) reserved bits indicative of the receive zone ID.

Aspect 15. The apparatus of Aspect 14, wherein the sidelink information further includes one or more SCI reserved bits indicative of the transmission zone ID.

Aspect 16. The apparatus of any one of Aspects 1 to 15, wherein: the sidelink information comprises Sidelink Control Information (SCI) information included in a physical sidelink control channel (PSCCH) transmission; and the groupcast message comprises a vehicle-to-everything (V2X) message included in a physical sidelink shared channel (PSSCH) transmission.

Aspect 17. The apparatus of any one of Aspects 1 to 16, wherein the UE is a vehicle-to-everything (V2X) UE, and wherein the groupcast message is a V2X groupcast message between the V2X UE and one or more receive candidate UEs located within the receive area.

Aspect 18. The apparatus of Aspect 17, wherein the range information is indicative of: a cardinal direction or an angular range relative to a current direction of movement of the V2X UE.

Aspect 19. The apparatus of any one of Aspects 17 or 18, wherein the receive area is located ahead of a current direction of movement of the V2X UE or behind the current direction of movement of the V2X UE.

Aspect 20. The apparatus of any one of Aspects 1 to 19, wherein: the geographical zone is included in a plurality of geographical zones associated with the zone indication type; and one or more of a shape or geometric dimensions of each respective geographical zone of the plurality of geographical zones is the same, based on the zone indication type.

Aspect 21. The apparatus of Aspect 20, wherein each respective geographical zone corresponds to one or more of a lane of a roadway, a portion of a lane of a roadway, or a direction of travel within a lane of a roadway.

Aspect 22. The apparatus of Aspect 20, wherein each respective geographical zone corresponds to a different level of a multi-level parking structure or a different level of a multi-level roadway.

Aspect 23. An apparatus of a first user equipment (UE) for wireless communications, comprising: at least one memory; and at least one processor coupled to the at least one memory, wherein the at least one processor is configured to: receive sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type determine a receive area comprising a portion of the geographical zone corresponding to the zone ID, wherein the receive area is determined based on directional information or angular information included in the range information; and decode a groupcast message received corresponding to the sidelink information, wherein the groupcast message is decoded based on a current location of the first UE being within the receive area.

Aspect 24. The apparatus of Aspect 23, wherein the sidelink information is configured to cause one or more candidate UEs located in the receive area to decode the groupcast message, the first UE included in the one or more candidate UEs.

Aspect 25. The apparatus of any one of Aspects 23 or 24, wherein the at least one processor is further configured to: transmit a hybrid automatic repeat request (HARQ) negative acknowledgement (NACK) corresponding to the groupcast message, wherein the HARQ NACK is indicative of unsuccessful decoding of the groupcast message by the first UE.

Aspect 26. The apparatus of any one of Aspects 23 to 25, wherein the sidelink information includes: a source Layer-2 (L2) ID indicative of one or more of the zone indication type associated with the groupcast message or the zone ID; and a destination L2 ID indicative of the range information.

Aspect 27. The apparatus of Aspect 26, wherein the sidelink information includes: a first destination L2 ID indicative of directional or angular information corresponding to a first receive area within the geographical zone; and a second destination L2 ID indicative of directional or angular information corresponding to a second receive area within the geographical zone, the first receive area different from the second receive area.

Aspect 28. The apparatus of Aspect 26, wherein the sidelink information includes: a first destination L2 ID indicative of a first range of height values corresponding to a first receive area within the geographical zone; and a second destination L2 ID indicative of a second range of height values corresponding to a second receive area within the geographical zone, the first receive area different from the second receive area.

Aspect 29. The apparatus of any one of Aspects 26 to 28, wherein the source L2 ID is further indicative of one or more of directional information of the geographical zone or height information of the geographical zone.

Aspect 30. The apparatus of any one of Aspects 23 to 29, wherein the geographical zone comprises a transmission zone for the groupcast message of the UE, and wherein the zone ID comprises a transmission zone ID corresponding to the transmission zone.

Aspect 31. The apparatus of Aspect 30, wherein the range information is based on a receive zone ID corresponding to a receive zone for the groupcast message.

Aspect 32. The apparatus of Aspect 31, wherein the receive area comprises an intersection between the receive zone and the transmission zone for the groupcast message.

Aspect 33. The apparatus of any one of Aspects 31 or 32, wherein: the receive zone is included in a plurality of configured receive zones; and the transmission zone is included in a plurality of configured transmission zones.

Aspect 34. The apparatus of Aspect 33, wherein the plurality of configured receive zones and the plurality of configured transmission zones are the same.

Aspect 35. The apparatus of any one of Aspects 31 to 34, wherein the sidelink information includes one or more Layer-2 (L2) IDs indicative of the receive zone ID.

Aspect 36. The apparatus of any one of Aspects 31 to 35, wherein the sidelink information includes one or more Sidelink Control Information (SCI) reserved bits indicative of the receive zone ID.

Aspect 37. The apparatus of Aspect 36, wherein the sidelink information further includes one or more SCI reserved bits indicative of the transmission zone ID.

Aspect 38. The apparatus of any one of Aspects 23 to 37, wherein: the sidelink information comprises Sidelink Control Information (SCI) information included in a physical sidelink control channel (PSCCH) transmission; and the groupcast message comprises a vehicle-to-everything (V2X) message included in a physical sidelink shared channel (PSSCH) transmission.

Aspect 39. The apparatus of any one of Aspects 23 to 38, wherein the first UE is a vehicle-to-everything (V2X)-capable UE and the second UE is a V2X UE, and wherein the groupcast message is a V2X groupcast message between the V2X UE and the V2X-capable UE.

Aspect 40. The apparatus of Aspect 39, wherein the range information is indicative of: a cardinal direction or an angular range relative to a current direction of movement of the V2X UE.

Aspect 41. The apparatus of any one of Aspects 39 or 40, wherein the receive area is located ahead of a current direction of movement of the V2X UE or behind the current direction of movement of the V2X UE.

Aspect 42. The apparatus of any one of Aspects 23 to 41, wherein: the geographical zone is included in a plurality of geographical zones associated with the zone indication type; and one or more of a shape or geometric dimensions of each respective geographical zone of the plurality of geographical zones is the same, based on the zone indication type.

Aspect 43. The apparatus of Aspect 42, wherein each respective geographical zone corresponds to one or more of a lane of a roadway, a portion of a lane of a roadway, or a direction of travel within a lane of a roadway.

Aspect 44. The apparatus of Aspect 42, wherein each respective geographical zone corresponds to a different level of a multi-level parking structure or a different level of a multi-level roadway.

Aspect 45. A method of wireless communications performed at a UE, comprising operations according to any of Aspects 1 to 22.

Aspect 46. A non-transitory computer-readable storage medium comprising instructions stored thereon which, when executed by at least one processor, causes the at least one processor to perform operations according to any one of Aspects 1 to 22.

Aspect 47. An apparatus for wireless communications, comprising one or more means for performing operations according to any one of Aspects 1 to 22.

Aspect 48. A method of wireless communications performed at a UE, comprising operations according to any of Aspects 23 to 44.

Aspect 49. A non-transitory computer-readable storage medium comprising instructions stored thereon which, when executed by at least one processor, causes the at least one processor to perform operations according to any one of Aspects 23 to 44.

Aspect 50. An apparatus for wireless communications, comprising one or more means for performing operations according to any one of Aspects 23 to 44.

1. An apparatus of a user equipment (UE) for wireless communications, comprising:
at least one memory; and
at least one processor coupled to the at least one memory, wherein the at least one processor is configured to:
determine a zone indication type for a groupcast message of the UE, wherein the zone indication type is included in a configured plurality of zone indication types;
determine a zone identity (ID) for a current location of the UE, wherein the current location of the UE is within a geographical zone corresponding to the zone ID, and wherein the zone ID is selected from a plurality of zone IDs of the zone indication type;
determine range information for the groupcast message, wherein the range information is indicative of a receive area within the geographical zone corresponding to the zone ID;
transmit sidelink information indicative of the zone ID and the range information; and
transmit the groupcast message.

2. The apparatus of claim 1, wherein the sidelink information is configured to cause one or more candidate UEs located in the receive area to decode the groupcast message.

3. The apparatus of claim 1, wherein the at least one processor is further configured to:
receive a hybrid automatic repeat request (HARQ) negative acknowledgement (NACK) corresponding to the groupcast message, wherein the HARQ NACK is indicative of unsuccessful decoding of the groupcast message by a candidate UE located in the receive area.

4. The apparatus of claim 1, wherein the sidelink information includes:
a source Layer-2 (L2) ID indicative of one or more of the zone indication type associated with the groupcast message or the zone ID; and
a destination L2 ID indicative of the range information.

5. The apparatus of claim 4, wherein the sidelink information includes:
a first destination L2 ID indicative of directional or angular information corresponding to a first receive area within the geographical zone; and
a second destination L2 ID indicative of directional or angular information corresponding to a second receive area within the geographical zone, the first receive area different from the second receive area.

6. The apparatus of claim 4, wherein the sidelink information includes:
a first destination L2 ID indicative of a first range of height values corresponding to a first receive area within the geographical zone; and
a second destination L2 ID indicative of a second range of height values corresponding to a second receive area within the geographical zone, the first receive area different from the second receive area.

7. The apparatus of claim 4, wherein the source L2 ID is further indicative of one or more of directional information of the geographical zone or height information of the geographical zone.

8. The apparatus of claim 1, wherein the geographical zone comprises a transmission zone for the groupcast message of the UE, and wherein the zone ID comprises a transmission zone ID corresponding to the transmission zone.

9. The apparatus of claim 8, wherein, to determine the range information for the groupcast message, the at least one processor is configured to:
determine a receive zone ID corresponding to a receive zone for the groupcast message.

10. The apparatus of claim 9, wherein the receive area comprises an intersection between the receive zone and the transmission zone for the groupcast message.

11. The apparatus of claim 9, wherein the at least one processor is configured to:
determine the receive zone from a plurality of configured receive zones; and
determine the transmission zone from a plurality of configured transmission zones.

12. The apparatus of claim 11, wherein the plurality of configured receive zones and the plurality of configured transmission zones are the same.

13. The apparatus of claim 9, wherein the sidelink information includes one or more Layer-2 (L2) IDs indicative of the receive zone ID.

14. The apparatus of claim 9, wherein the sidelink information includes one or more Sidelink Control Information (SCI) reserved bits indicative of the receive zone ID.

15. The apparatus of claim 14, wherein the sidelink information further includes one or more SCI reserved bits indicative of the transmission zone ID.

16. The apparatus of claim 1, wherein:
the sidelink information comprises Sidelink Control Information (SCI) information included in a physical sidelink control channel (PSCCH) transmission; and
the groupcast message comprises a vehicle-to-everything (V2X) message included in a physical sidelink shared channel (PSSCH) transmission.

17. The apparatus of claim 1, wherein the UE is a vehicle-to-everything (V2X) UE, and wherein the groupcast message is a V2X groupcast message between the V2X UE and one or more receive candidate UEs located within the receive area.

18. The apparatus of claim 17, wherein the range information is indicative of:
a cardinal direction or an angular range relative to a current direction of movement of the V2X UE.

19. The apparatus of claim 17, wherein the receive area is located ahead of a current direction of movement of the V2X UE or behind the current direction of movement of the V2X UE.

20-22. (canceled)

23. An apparatus of a first user equipment (UE) for wireless communications, comprising:
at least one memory; and
at least one processor coupled to the at least one memory, wherein the at least one processor is configured to:
receive sidelink information indicative of range information and a zone identity (ID) corresponding to a current location of a second UE, wherein the current location of the second UE is within a geographical zone corresponding to the zone ID, and wherein the zone ID is included in a plurality of zone IDs of a particular zone indication type
determine a receive area comprising a portion of the geographical zone corresponding to the zone ID, wherein the receive area is determined based on directional information or angular information included in the range information; and
decode a groupcast message received corresponding to the sidelink information, wherein the groupcast message is decoded based on a current location of the first UE being within the receive area.

24-30. (canceled)
